(19) United States
(12) Patent Application Publication
(10) Pub. No.: US 2026/0346763 A1
(43) Pub. Date: Nov. 5, 2026

(54) INFANT BASKET, TOP TETHER SYSTEM, CONNECTING STRUCTURE AND CHILD SAFETY SEAT

(71) Applicant: Wonderland Switzerland AG, Steinhausen (CH)

(72) Inventors: Ruyi LI, Guangdong (CN); Ganqing FANG, Guangdong (CN); Zhengwen GUO, Guangdong (CN); Xiong YU, Guangdong (CN); Qiang YANG, Guangdong (CN); Ziqiang HE, Guangdong (CN); Daliang ZHANG, Guangdong (CN)

(73) Assignee: Wonderland Switzerland AG, Steinhausen (CH)

(21) Appl. No.: 19/487,391

(22) PCT Filed: May 24, 2024
(86) PCT No.: PCT/EP2024/064410

§ 371 Date: Nov. 24, 2025

(30) Foreign Application Priority Data
May 24, 2023 (CN) 202310597421.6
Jul. 21, 2023 (CN) 202310904400.4
Sep. 1, 2023 (CN) 202311127270.4
Sep. 4, 2023 (CN) 202311132483.6
Oct. 24, 2023 (CN) 202311392028.X
May 10, 2024 (CN) 202410581943.1

(51) Int. Cl. B60N 2/28; A47D 9/00

(52) U.S. Cl. CPC B60N 2/2821; A47D 9/005; A47D 9/008

(57) ABSTRACT

The present invention relates to an infant basket and a child safety seat. The side portion of the infant basket is provided with an engaging member and a cover member; the engaging member defines a slot structure for engaging with an external safety belt, and the slot structure has an engaging opening, which is used for the external safety belt to enter or leave the slot structure; the cover member has a first working mode and a second working mode, in the first working mode, the cover member covers at least a portion of the engaging opening to restrict the external safety belt from entering the slot structure; in the second working mode, the cover member releases the cover of the engaging opening and allows the external safety belt to enter the slot structure.

### TECHNICAL FIELD

The present invention relates to an infant basket, a top tether system, a connecting structure infant basket and a child safety seat.

### BACKGROUND

Infant baskets are utilized in both vehicles and airplanes to ensure the safe transportation of infants. When installed in a vehicle, these baskets is detachable connected to a base that is mounted on the vehicle seat. The base can be secured using either ISOFIX or LATCH systems, or it can be fastened with the vehicle's three-point safety belt. Since the use of infant baskets in vehicles is more common than in airplanes, current designs do not include a feature for positioning the vehicle's safety belt, so as to prevent improper use, such as incorrectly wrapping the safety belt around the basket, which could lead to the base's fixation failure. Similarly, when an infant basket is used in an airplane, it presents challenges in securing it with the aircraft's safety belt system.

Certain existing child safety seats, which comprise both the seat body and base, necessitate ISOFIX attachment points for securing them to the vehicle. Additionally, they often require a top tether, or pull-up strap, for extra fixation. The top tether is typically an integral part of the seat body. However, the inventors have identified that a child safety seat with a permanently attached top tether adds to the weight of the seat body. This makes it less convenient to disassemble the seat body from the base for separate use. For instance, when the seat body doubles as an infant basket, the added weight can make it more cumbersome for users to handle.

To enable the attachment of child safety seats and their related accessories, it is essential to design a dedicated connecting structure on the child safety seat. This structure should facilitate the secure attachment of accessories, such as a top tether, which is crucial for firmly anchoring the child safety seat to the vehicle seat. The design of such a connecting structure is therefore imperative to enhance the functionality and user experience of child safety seats.

### SUMMARY

An infant basket according to the present invention, and the side portion of the infant basket is provided with an engaging member and a cover member; the engaging member defines a slot structure for engaging with an external safety belt, and the slot structure has an engaging opening, which is used for the external safety belt to enter or leave the slot structure; the cover member has a first working mode and a second working mode, in the first working mode, the cover member covers at least a portion of the engaging opening to restrict the external safety belt from entering the slot structure; in the second working mode, the cover member releases the cover of the engaging opening and allows the external safety belt to enter the slot structure.

In one embodiment, the infant basket comprises a body, which forms a space for infants to ride in; the engaging member comprises a connection portion and an extension portion, the connection portion extends outward from the side portion of the body, the extension portion extends from the outer end of the connection portion, and the extension direction of the extension portion forms an angle with the extension direction of the connection portion.

In one embodiment, the connection portion, the extension portion, and the side portion of the body jointly define the slot structure; the engaging opening is formed between one end of the extension portion away from the connection portion and the side portion of the body.

In one embodiment, the cover member is provided with a first opening corresponding to the position of the engaging member; in the first working mode, the cover member covers the engaging opening; when switching to the second working mode, the engaging member is adapted to pass through the first opening and expose the engaging opening outside the cover member.

In one embodiment, the first opening is a hole or a slit, and/or the cover member is provided with a sealing member for sealing the first opening.

In one embodiment, in the extension direction of the engaging member, the dimension of the first opening is smaller than the dimension of the engaging member; in the height direction perpendicular to the extension direction of the engaging member, the dimension of the first opening is greater than the dimension of the engaging member;

In one embodiment, in the first working mode, the first opening deviates from the engaging opening.

In one embodiment, a first positioning structure is set between the cover member and the body, the cover member is detachably connected to the body through the first positioning structure; when the first positioning structure releases the positioning of the cover member, it allows the engaging member to pass through the first opening and expose the engaging opening outside the cover member.

In one embodiment, the infant basket comprises a body and a seat cloth, the seat cloth comprises a skirt edge that is folded outward from the upper edge of the body, and at least a portion of the skirt edge forms the cover member; a first positioning structure is provided between the skirt edge and the body; in the first working mode, the skirt edge covers the engaging member and is detachably connected to the body through the first positioning structure; when switching to the second working mode, the first positioning structure releases the positioning of the skirt edge to allow the skirt edge to move upwards and expose the engaging opening;

In one embodiment, the first positioning structure is provided between the skirt edge and the side portion of the body.

In one embodiment, the infant basket comprises a body and a seat cloth, wherein the seat cloth comprises a skirt edge that is folded outward from the upper edge of the body, and the skirt edge is provided with a second opening, and the engaging member penetrates from the second opening; the cover member includes a movable cover connected to the seat cloth; in the first working mode, the movable cover covers the engaging member and is connected to the seat cloth through a second positioning structure; when switching to the second working mode, the second positioning structure releases the positioning of the movable cover to allow the movable cover to move and expose the engaging member.

In one embodiment, a portion of the edge of the movable cover is sewn together with the seat cloth; alternatively, the movable cover can be detachably connected to the seat cloth.

In one embodiment, the infant basket comprises a body, which forms a space for infants to ride in; the side portion of the body is provided with a recess, and the engaging member is located within the recess; the cover member comprises a cover body, in the first working mode, the cover body is located on the recess and covers the engaging member; when switching to the second working mode, the cover body opens the recess and exposes the engaging member.

In one embodiment, the cover body is pivotally connected to the body; and/or, the cover body is made of plastic or metal.

In one embodiment, the infant basket comprises a body and a seat cloth, at least a portion of the seat cloth forms the cover member.

In one embodiment, the seat cloth comprises a skirt edge that is folded outward from the upper edge of the body, and the skirt edge forms the cover member.

In one embodiment, the interior of the cover member forms an accommodating space; the first end of the cover member is a fixed end, and the second end of the cover member is a free end; the cover member is provided with a third opening that is in communication with the accommodating space, and the third opening is located between the first end of the cover member and the second end of the cover member; in the first working mode, the cover member is covered on the engaging member, and the engaging member enters into the accommodating space through the third opening.

In one embodiment, the third opening is close to the second end of the cover member.

In one embodiment, the infant basket comprises a body and a seat cloth, the seat cloth comprises a skirt edge that is folded outward from the upper edge of the body, and the first end of the cover member is connected to the skirt edge or the body.

In one embodiment, the infant basket comprises a body, and a limit hole is provided on the side portion of the body; the first end of the cover member is inserted into the limit hole, and the first end of the cover member is provided with a limit member that is clamped with the limit hole;

In one embodiment, the cover member comprises first and second surfaces that are opposite to each other, the accommodating space is located between the first and second surfaces, the third opening is set on the first surface; in the second working mode, the cover member is separated from the engaging member; when transitioning from the second working mode to the first working mode, the cover member flips relative to its first end, causing the first surface to approach the engaging member.

In one embodiment, the infant basket has a first using mode and a second using mode; in the first using mode, the infant basket is suitable for application in vehicles; in the second using mode, the infant basket is suitable for application in aircraft; when the infant basket is in the first using mode, making the cover member in the first working mode, the infant basket is suitable for detachable installation to a base, and the base is suitable for installation on a vehicle seat; when the infant basket is in the second using mode, making the cover member in the second working mode, and the infant basket is suitable for installation on the aircraft seat through a safety belt passing through the slot structure.

A child safety seat according to the present invention, comprising the above-mentioned infant basket.

According to the present application, the infant basket can be switched to the first or second using mode by switching the cover member to the first or second working mode. The first working mode of the cover member corresponds to the first using mode of the infant basket, and the second working mode of the cover member corresponds to the second using mode of the infant basket. In the first using mode, the infant basket is suitable for use in vehicles and can be installed on the vehicle seat through a base. At this time, the cover member in the first working mode can prevent the vehicle safety belt from entering the slot structure through the engaging opening, effectively avoiding the user's incorrect installation of the vehicle safety belt into the slot structure and causing the fixation failure of the base. When the infant basket is in the second using mode, it is suitable for application in the aircraft, such as directly placing the infant basket on the aircraft seat (not shown in the Fig.). At this point, the cover member in the second working mode releases the cover of the engaging opening and allows the safety belt to enter the slot structure. The safety belt passes through the slot structure and reliably installs the infant basket on the aircraft seat.

A top tether system according to the present application, which is for connecting a child safety seat to a vehicle, the child safety seat comprises a seat body and a base that are detachably connected to each other, and the top tether system comprises a first part and a second part that are detachably connected to each other, at least one of the first and second parts is a flexible strap structure, the first part is configured to connect the seat body, and the second part is configured to connect the vehicle; wherein, the first part is restricted from detaching from the seat body, the second part is configured to connect with the base and is restricted from detaching from the base.

In one embodiment, the first and second parts are both flexible strap structures.

In one embodiment, the second part has a first end and a second end, and the top tether system further comprising: a first connecting member that is provided at the first end and configured to connect the vehicle; a second connecting member that is provided at the second end and detachably connected to the first part.

In one embodiment, the top tether system further comprising: a third connecting member that is provided in the first part and used for connecting in coordination with the second connecting member.

In one embodiment, one of the second connecting member and the third connecting member has a hook, and the other of the second connecting member and the third connecting member has a connecting hole, and the hook is snap fitted with the connecting hole.

In one embodiment, the first part has a surrounding portion, which is configured to surround and fixedly connect to the back of the seat body.

In one embodiment, the top tether system further comprises a fixing member connected to the back of the seat body, the surrounding portion of the first part has a first fixing portion, and the first fixing portion is connected in coordination with the fixing member.

In one embodiment, the first fixing portion of the surrounding portion of the first part is sleeve shaped and sleeved on the fixing member.

In one embodiment, the first fixing portion of the surrounding portion of the first part is elastic, so that the first fixing portion is elastically deformed and sleeved on the fixing member.

In one embodiment, the fixing member has an installation portion for installing on the back of the seat body and a second fixing portion connected to the installation portion, with a gap between the installation portion and the second fixing portion, the first fixing portion is sleeved on the second fixing portion and partially located in the gap.

In one embodiment, one end of the second fixing portion of the fixing member is connected to the installation portion of the fixing member, and the other end of the second fixing portion is suspended to form an opening for the fixing member.

In one embodiment, the second fixing portion of the fixing member is equipped with a blocking portion at the position corresponding to the opening, the blocking portion restricts the first fixing portion from detaching from the second fixing portion to restrict the first part from detaching from the seat body.

In one embodiment, the surrounding portion of the first part is a closed circular structure, the first part has an extension portion connected to the surrounding portion, and the extension portion is connected to the second part.

In one embodiment, the surrounding portion of the first part has two free ends, and the second part includes one first end and two second ends, the first end is configured to connect the vehicle, and the two free ends are detachably connected to the two second ends, respectively.

In one embodiment, the second part is a Y-shaped flexible strap structure.

In one embodiment, the first part is a non-flexible structure fixed to the seat body, and the second part is a flexible strap structure.

In one embodiment, the second part has a first end and a second end, and the top tether system further comprising: a first connecting member that is provided at the first end and configured to connect the vehicle; a second connecting member that is provided at the second end and detachably connected to the first part.

In one embodiment, one of the second connecting member and the first part has a hook, the other of the second connecting member and the first part has a fixing hole, and the hook is snap fitted with the fixing hole.

In one embodiment, the first part is configured to fix to the back of the seat body, and the first part includes two fixing holes, the second part has two second ends for connecting to the two second connecting members respectively, each of the two second connecting members has a hook, and the two hooks and two fixing holes are connected and clamped one by one correspondence.

In one embodiment, the first part is installed and fixed on the seat body; or the first part is fixed to the seat body through integrated formation.

In one embodiment, the second part is a Y-shaped flexible strap structure.

In one embodiment, the first part is configured to fix to the seat body, the second part is a flexible strap structure, the second part has a surround portion, the surround portion is configured to surround the back of the seat body, and the surround portion is detachably connected to the first part.

In one embodiment, the second part has one first end and two second ends, and the top tether system further comprising: a first connecting member that is provided at the first end and configured to connect the vehicle; two fourth connecting members that are respectively provided at the two second ends and can be detachably connected to each other.

In one embodiment, one of the two fourth connecting members has a hook, the other of the two fourth connecting members has a connecting hole, and the hook is snap fitted with the connecting hole.

In one embodiment, the length from one fourth connecting member to the first end is greater than the length from another fourth connecting member to the first end.

In one embodiment, the surround portion passes through the first part, and two fourth connecting members are used for detachably connected on the outer side of the first part.

In one embodiment, the first part has an installation portion for installing on the back of the seat body and a second fixing portion connected to the installation portion, with a gap between the installation portion and the second fixing portion, and the surround portion of the second part passes through the gap.

In one embodiment, one end of the second fixing portion of the first part is connected to the installation portion of the first part, and the other end of the second fixing portion is suspended to form an opening for the first part.

In one embodiment, the second fixing portion of the first part is equipped with a blocking portion at the position corresponding to the opening, the blocking portion restricts the surround portion of the second part from detaching from the gap to restrict the second part from detaching from the seat body.

In one embodiment, the first part is installed and fixed to the seat body; or the first part is fixed to the seat body through integrated formation.

In one embodiment, the second part is a Y-shaped flexible strap structure.

In one embodiment, the second part is a flexible strap structure, and the top tether system further includes an adjusting member located in the second part for adjusting the length of the second part.

In one embodiment, the first part is located on the outer side of the back of the seat body.

In one embodiment, the second part is configured to connect to a top rod structure of the base, and the top rod structure is configured to abut the vehicle.

A child safety seat according to the present application comprises a seat body, a base, and a top tether system, the top tether system is configured to connect the child safety seat to a vehicle, the seat body and the base are detachably connected.

In one embodiment, the first part of the top tether system is a flexible strap structure, and the child safety seat further comprises a storage bag for storing the first part, the storage bag is connected to the first part or the seat body.

In one embodiment, the first part of the top tether system is a flexible strap structure, and the child safety seat further comprises a seat cloth provided on the seat body and a storage bag for storing the first part, the storage bag is connected to the seat cloth.

In one embodiment, the base is equipped with a top rod structure for abutting the vehicle, and the second part of the top tether system is connected to the top rod structure.

In one embodiment, the second part is a flexible strap structure, and the top rod structure has a penetration portion, the second part passes through the penetration portion and is restricted from detaching from the penetration portion.

In one embodiment, the wall surface of the abut portion of the top rod structure is penetrated to form the penetration portion; or the top rod structure has a connection portion adjacent to the abut portion, and the penetration portion is formed between the abut portion and the connection portion.

In one embodiment, the top tether system comprises a first connecting member and a second connecting member both connected to the second part, the first connecting member is configured to connect the vehicle, the second connecting member is configured to connect the first part of the top tether system, and at least one of the first connecting member and the second connecting member is restricted from passing through the penetration portion.

A child safety seat according to the present application, comprising a seat body, a base, and a top tether system. The top tether system is configured to connect the child safety seat to the vehicle, the seat body and base can be detachably connected.

In one embodiment, the base has a top rod structure for abutting the vehicle, and the second part of the top tether system is connected to the top rod structure.

In one embodiment, the second part is a flexible strap structure, the top rod structure comprises a penetration portion, the second part passes through the penetration portion and is limited to detach from the penetration portion.

In one embodiment, the wall surface of the abut portion of the top rod structure penetrates to form a penetration portion; alternatively, the top rod structure has a connection portion, which is adjacent to the abut portion, and a penetration portion is formed between the abut portion and the connection portion.

In one embodiment, the top tether system comprises a first connecting member and a second connecting member both connected to the second part, the first connecting member is configured to connect the vehicle, the second connecting member is configured to connect the first part of the top tether system, and at least one of the first and second connecting members is restricted from passing through the penetration portion.

Another child safety seat according to the present application, comprising a seat body, a base, and a top tether system. The top tether system is configured to connect the child safety seat to the vehicle, and the seat body and base can be detachably connected.

In one embodiment, the base has a top rod structure for abutting the vehicle, and the second part of the top tether system is connected to the top rod structure.

In one embodiment, the second part is a flexible strap structure, the top rod structure comprises a penetration portion, the second part passes through the penetration portion and is limited to detach from the penetration portion.

In one embodiment, the wall surface of the abut portion of the top rod structure penetrates to form a penetration portion; or the top rod structure has a connection portion, which is adjacent to the abut portion, and a penetration portion is formed between the abut portion and the connection portion.

In one embodiment, the top tether system includes a first connecting member and a fourth connecting member that are both connected to the second part, the first connecting member and the fourth connecting member are located on both sides of the penetration respectively, and at least one of the first and fourth connecting members is restricted from passing through the penetration portion.

A connecting structure according to the present application provided on a carrier, wherein the connecting structure comprising: an accommodating portion with an accommodating chamber; a first connecting member, housed in the accommodating chamber, that is used for detachably connecting with a second connecting member to connect the second connecting member to the carrier; and a cover body that is movably connected to the accommodating portion and can be switched between an open position and a closed position relative to the accommodating portion; wherein when the cover body is in the open position, the cover body allows the second connecting member to enter or leave the accommodating chamber; and when the cover body is in the closed position, the cover body obstructs the accommodating chamber.

In one embodiment, the accommodating chamber has an opening that opens outward; when the cover body is in the open position, the cover body allows the second connecting member to pass through the opening to enter or leave the accommodating chamber, and when the cover body is in the closed position, it at least partially closes the opening to obscure the accommodating chamber.

In one embodiment, the accommodating portion has first and second side walls opposite each other, the first side wall and the second side wall are respectively provided with a shaft hole, and the cover body comprises a pivot shaft and a free end opposite to the pivot shaft; the pivot shaft is inserted into the shaft hole to allow the cover body to pivot relative to the accommodating portion, and when the cover body is in the closed position, the free end closes the opening of the accommodating portion.

In one embodiment, the first side wall and the second side wall are respectively provided with an open positioning recess and a closed positioning recess around the shaft hole, and the cover body is provided with a positioning protrusion around the pivot shaft, when the cover body is in the open position and the closed position, the positioning protrusion engages with the open positioning recess and the closed positioning recess, respectively; or the first side wall and the second side wall are respectively provided with a open positioning protrusion and a closed positioning protrusion around the shaft hole, and the cover body is provided with a positioning recess around the pivot shaft, when the cover body is in the open position and the closed position, the positioning recess engages with the open positioning protrusion and the closed positioning protrusion, respectively.

In one embodiment, the first connecting member slides in a sliding direction within the accommodating chamber between a locking position and an unlocking position.

In one embodiment, the accommodating portion further comprises an inner side surface and an extension wall, the inner side surface is set opposite to the opening, and the extension wall extends towards the opening from the inner side surface to form a clamping space; and the clamping space limits the second connecting member to enter the accommodating portion along an insertion direction to engage with the first connecting member.

In one embodiment, the extension wall further forms a yielding space, which is connected to the clamping space, and when the first connecting member is in the locking position, the first connecting member is at least partially located within the yielding space.

In one embodiment, the extension wall is integrated with the inner side surface and enclosed to form the clamping space and the yielding space.

In one embodiment, a connecting hole is provided in the first connecting member; and the accommodating portion further comprises a guide groove, a guiding member passes through the guide groove and is connected to the connecting hole to limit the sliding direction of the first connecting member.

In one embodiment, the sliding direction of the first connecting member intersects with the insertion direction of the second connecting member; and the first connecting member is set to automatically move to the unlocking position when the second connecting member enters the connecting structure, and reset to the locking position after the second connecting member enters the connecting structure.

In one embodiment, the second connecting member is constructed so that when the first connecting member is in the locking position, the second connecting member is embedded into the first connecting member under the action of outward pulling force.

In one embodiment, the cover body rotates around a pivot shaft between the open position and the closed position, and the pivot shaft is perpendicular to the sliding direction of the first connecting member and the insertion direction of the second connecting member.

In one embodiment, the connecting structure further comprises a resetting member arranged in the accommodating portion, the resetting member biases the first connecting member towards the locking position.

In one embodiment, the first connecting member further comprising: at least one abut portion, the abut portion limits the resetting member, and at least a portion of the extension wall is directly opposite to the abut portion along the sliding direction.

In one embodiment, the first connecting member comprising: a hook portion, closed to the locking position, that is constructed to lock the second connecting member in the connecting structure; as well as a pressing portion facing the outer side of the accommodating portion, constructed to be pressed to move the first connecting member.

In one embodiment, the hook portion comprising: a clamping portion that is provided at a position facing the inner side of the accommodating portion of the hook portion, and when the first connecting member is in the locking position, the second connecting member is engaged into the clamping portion; as well as an inclined plane that is provided on the outer side of the hook portion and inclined towards the inner side of the accommodating portion to allow the second connecting member to abut against the inclined plane to move the first connecting member towards the unlocking position during the process of the second connecting member entering the connecting structure.

In one embodiment, the hook portion is constructed to pass through as a clamping hole of the second connecting member; and the clamping portion is a groove that is recessed outward into the hook portion, allowing the second connecting member to engage into the clamping portion of the hook portion.

In one embodiment, when the cover body is in the closed position, a gap is provided between the cover body and the accommodating portion to allow the tether connected to the second connecting member to extend from the gap to the outside of the connecting structure.

In one embodiment, the accommodating portion is an independent component installed on the carrier; or the accommodating portion is a part that is integrally formed with the carrier.

A child safety seat according to the present application, wherein the child safety seat comprising: a seat body that includes a seating portion, a leaning portion, and two side wings located on each side of the leaning portion; two connecting structures, located on two side wings respectively, each including an accommodating portion and a first connecting member, wherein the first connecting member is located within the accommodating portion and can slide relative to the accommodating portion between an unlocking position and a locking position along the seat body; as well as a tether connected to the two connecting structures.

In one embodiment, the tether comprising: two branch portions, one end of each branch portion connected to the two connecting structures, and the other end of each branch portion merged with each other; and an extension portion extended from the merged ends of the branch portions and being configured to connect to a vehicle.

In one embodiment, each branch portion is connected to the connecting structure through a second connecting member, and the connecting structure includes a cover body that can cover the first connecting member; when the first connecting member is in the locking position, the first connecting member can lock the second connecting member to the connecting structure, when the first connecting member is in the unlocking position, the second connecting member can enter and leave the connecting structure.

In one embodiment, the tether extends along the longitudinal direction of the child safety seat, and the second connecting member is inserted into the connecting structure along the lateral direction of the child safety seat.

In one embodiment, the accommodating portion is installed on the seat body or integrally formed with the seat body.

In one embodiment, the leaning portion is located behind the seating portion and extends upwards; the child safety seat further includes a carrying handle, which has two pivot portions connected to both sides of the seat body, each pivot portion having a pivot center, and the carrying handle can rotate relative to the seat body around the pivot center; the connecting structure is set on the side wing and is close to the rear and upper parts of the seat body relative to the pivot center.

In one embodiment, the side wing has an extending portion extending outward and downward from its upper edge, and the connecting structure is located below the extending portion.

In one embodiment, the child safety seat is detachably connected to a base; the leaning portion is located behind the seating portion and extends upwards, and the seat body further comprises two connection portions connected to the seating portion, the two connection portions are spaced apart and both extend downwards, the two connection portions are constructed to be connected in coordination with the base, and the connecting structure is close to the upper part of the seat body relative to the connection portion.

### BRIEF DESCRIPTION OF THE DRAWINGS

The drawings forming a part of the present application are configured to provide a further understanding of the present invention, and the illustrative embodiments and their explanations of the present invention are configured to explain the present invention and do not constitute an improper limitation of the present invention.

FIG. 1 schematically illustrates a perspective view of a child safety seat provided according to some embodiments of the present invention, which comprises an infant basket provided according to some embodiments of the present invention;

FIG. 2 schematically illustrates a perspective view of the infant basket in FIG. 1, with the seat cloth omitted;

FIG. 3 schematically illustrates a perspective view of the base in FIG. 1;

FIG. 4 schematically illustrates a top view of the infant basket shown in FIG. 2;

FIG. 5 schematically illustrates a side view of the infant basket in FIG. 1, which is in the first using mode;

FIG. 6 schematically illustrates a side view of the infant basket in FIG. 1, which is in a second using mode;

FIG. 7 schematically illustrates a side view of the infant basket provided according to some embodiments of the present invention, wherein the infant basket is in the first using mode;

FIG. 8 schematically illustrates a side view of the infant basket shown in FIG. 7 in the second using mode;

FIG. 9 schematically illustrates a side view of the infant basket provided according to some embodiments of the present invention, wherein the infant basket is in the second using mode;

FIG. 10 schematically illustrates a side view of the infant basket provided according to some embodiments of the present invention, wherein the infant basket is in the second using mode;

FIG. 11 schematically illustrates a side view of the infant basket provided according to some embodiments of the present invention, wherein the infant basket is in the first using mode;

FIG. 12 schematically illustrates a side view of the infant basket shown in FIG. 11 in the second using mode;

FIG. 13 schematically illustrates a perspective view of the infant basket provided according to some embodiments of the present invention, wherein the infant basket is in the first using mode;

FIG. 14 schematically illustrates a perspective view of the infant basket provided according to some embodiments of the present invention, wherein the infant basket is in the second using mode;

FIG. 15 schematically illustrates a perspective view of the infant basket provided according to some embodiments of the present invention, wherein the infant basket is in the first using mode;

FIG. 16 schematically illustrates a partial enlarged view along U-U in FIG. 15;

FIG. 17 is a perspective view of the first embodiment of the child safety seat according to the present invention;

FIG. 18 shows the state of the seat body when the seat body of the child safety seat in FIG. 17 leaves the base;

FIG. 19 shows the state of the base after the seat body of the child safety seat in FIG. 17 is removed;

FIG. 20 is a partial perspective view of the child safety seat in FIG. 17;

FIG. 21 is a side sectional view of the child safety seat according to FIG. 17;

FIG. 22 is an enlarged schematic view of the boxed area A in FIG. 21;

FIG. 23 is a perspective view of the second embodiment of the child safety seat according to the present invention;

FIG. 24 is another perspective view of the child safety seat according to FIG. 23;

FIG. 25 shows the state of the seat body, when the seat body of the child safety according to FIG. 23 seat leaves the base;

FIG. 26 shows the state of the base after the seat body of the child safety seat according to FIG. 23 is removed;

FIG. 27 is a perspective view of the third embodiment of the child safety seat according to the present invention;

FIG. 28 is another perspective view of the child safety seat according to FIG. 27;

FIG. 29 shows the state of the seat body when the seat body of the child safety seat according to FIG. 27 leaves the base;

FIG. 30 is an enlarged schematic view of the boxed area B in FIG. 29;

FIG. 31 shows the state of the base after the seat body of the child safety seat according to FIG. 27 is removed;

FIG. 32 is a perspective view of the fourth embodiment of the child safety seat according to the present invention;

FIG. 33 is a perspective view of the second part of the top tether system of the fourth embodiment of the child safety seat according to the present invention after the second part is connected;

FIG. 34 shows the state of the seat body when the seat body of the child safety seat according to FIG. 32 leaves the base;

FIG. 35 is a side sectional view of the seat body according to FIG. 34;

FIG. 36 is an enlarged view of the boxed area C in FIG. 35;

FIG. 37 shows the state of the base after the seat body of the child safety seat according to FIG. 32 is removed;

FIG. 38A is a side view of the child safety seat according to the present application, wherein the cover body of the connecting structure is in the open position;

FIG. 38B is a partial enlarged view of the box in FIG. 38A;

FIG. 39A is a side view of the child safety seat according to the present application, wherein the cover body of the connecting structure is in the closed position;

FIG. 39B is a partial enlarged view of the box in FIG. 39A;

FIG. 40 is a side view of the child safety seat from another side;

FIG. 41 is a front view of the child safety seat, illustrating the connection portion;

FIG. 42A is a perspective view of the child safety seat, illustrating the connection portion;

FIG. 42B is a schematic perspective view of the child safety seat, illustrating the way in which the tether is connected to the seat body through the connecting structure;

FIG. 43 is a perspective exploded view of the connecting structure according to the present application, wherein the second connecting member and the tether are also shown;

FIG. 44 is a perspective view of the accommodating portion of the connecting structure;

FIGS. 45A and 45B are perspective views of the cover body of the connecting structure at different angles;

FIGS. 46A and 46B are perspective views of the first connecting member of the connecting structure at different angles;

FIG. 47 is a perspective view of the tether;

FIG. 48A is a perspective view of the connecting structure, with the cover body in the open position;

FIG. 48B is a perspective view of the connecting structure, with the cover body removed to show other components;

FIG. 49 is a sectional view of the connecting structure taken along the line E-E in the FIG. 38B, showing a second connecting member that has not entered the connecting structure;

FIG. 50 is a sectional view of the connecting structure, showing a second connecting member entering the connecting structure;

FIG. 51 is a sectional view of the connecting structure, showing the second connecting member against the inclined plane of the first connecting member, causing the inclined plane to move to the unlocking position;

FIG. 52 is a sectional view of the connecting structure, showing a second connecting member that has entered the connecting structure but has not been embedded in the clamping portion;

FIG. 53 is a sectional view of the connecting structure, showing a second connecting member that has entered the connecting structure and has been embedded in the clamping portion;

FIG. 54 is a sectional view of the connecting structure, showing an opening obscured by the cover in the connecting structure.

### DETAILED DESCRIPTION

Although the description refers to specific embodiments to illustrate and describe the present invention, the present invention should not be limited to the details shown. More precisely, within the scope of the equivalent solutions of the claims and without departing from the present invention, various modifications can be made to these details.

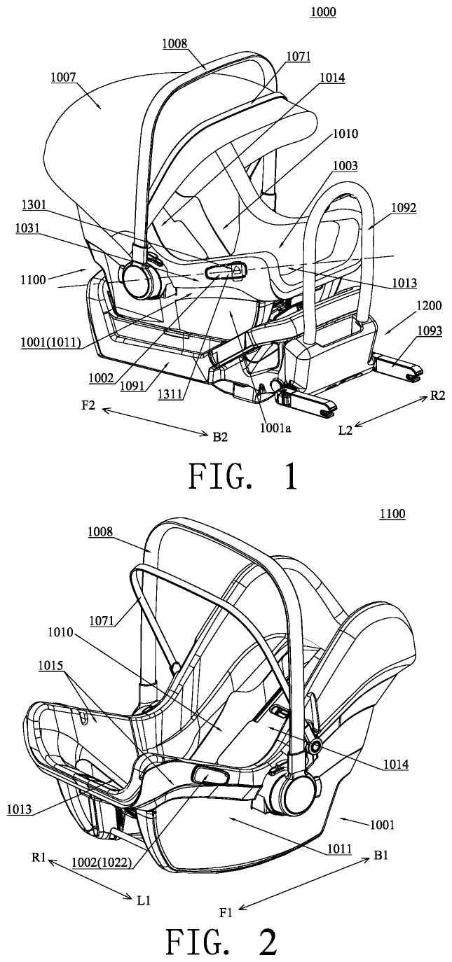

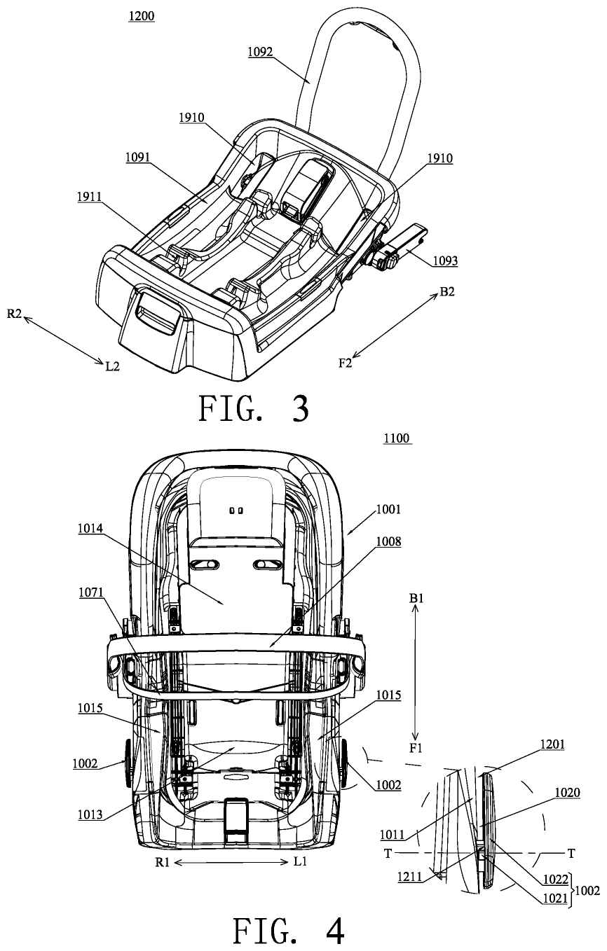

FIG. 1 shows a perspective view of a child safety seat 1000 provided according to some embodiments of the present invention, the child safety seat 1000 comprises a base 1200 and an infant basket 1100 provided according to some embodiments of the present invention. FIG. 2 shows a perspective view of the infant basket 1100 provided according to some embodiments of the present invention, and FIG. 3 shows a perspective view of the base 1200 provided according to some embodiments of the present invention.

Referring to FIGS. 1 and 2, the infant basket 1100 may include a body 1001. The inner side of the body 1001 forms a space 1010 for infants to sit in. The body 1001 includes a seat portion 1013 and a backrest portion 1014. The seat portion 1013 is configured to support the child's hip, and the backrest portion 1014 is configured to support the child's back. The left and right sides of the seat portion 1013 and the backrest portion 1014 have side wings 1015, which provide protection for infants in left and right directions. The body 1001 can include a plastic shell composed of plastic molded parts and a foam plastic engaged with the plastic shell. The foam plastic is usually located on the inner side and left and right sides of the plastic shell, so that the infant basket 1100 has a cushioning performance. The area used for contact with infants in the body 1001 can also be covered by a seat cloth 1003, and a buffer filling material can be filled between the seat cloth 1003 and the body 1001, for example, including a sponge layer. The body 1001 can further be equipped with a roof 1007 and a handle 1008. The roof 1007 is supported by a roof support 71 and can be unfolded or folded as needed. The handle 1008 is pivot connected to the body 1001, and users can easily move the infant basket 1100 through the handle 1008.

It should be noted that in the embodiments of the present invention, the directional terms “front”, “back”, “left”, “right”, etc. of the infant basket 1100 are based on the “front”, “back”, “left”, “right” directions of the child sitting in the infant basket 1100, and the arrows F1 and B1 are configured to illustrate the “front” and “back” directions of the infant basket 1100, as well as the arrows L1 and R1 are configured to illustrate the “left” and “right” directions of the infant basket 1100. These directional terms are provided for clarity purpose for the embodiments of the present invention, while not intended to improperly limit the scope of protection of the present invention.

Referring to FIGS. 1 and 3, the base 1200 can be placed on the vehicle seat (not shown in the Figs.) and provide stable support for the infant basket 1100. The base 1200 can include a seat body 1091, a top rod 1092 installed on the seat body 1091, and a connecting member 1093. The seat body 1091 is used for installation on the vehicle seat (not shown in the Figs.), and the body 1001 of the infant basket 1100 can be detachably installed on the seat body 1091. The seat body 1091 can be equipped with a locking mechanism 1911, and the body 1001 of the infant basket 1100 can be locked onto the seat body 1091 by the locking mechanism 1911. When the locking mechanism 1911 is unlocked, the body 1001 of the infant basket 1100 can be removed from the seat body 1091.

The top rod 1092 extends upwards from the rear end of the seat body 1091, and is configured to rest against the backrest of the vehicle seat. The connecting member 1093 is installed at the rear end of the seat body 1091 and can be plugged into the universal socket on the vehicle seat. The connecting member 1093 can be an ISOFIX connecting member or a LATCH connecting member. In some embodiments, holes 1910 can be provided on the left and right sides of the rear end of the seat body 1091, and the male buckle of the three-point car seat belt that matches the vehicle seat can pass through the hole 1910 on one side and then exit from the hole 1910 on the other side, and be connected to the socket on the vehicle seat. In other embodiments, a top tether (not shown in the Fig.) can be installed on the seat body 1091 or infant basket 1100, and the top tether can across above the vehicle seat and then be connected to the anchor point behind the vehicle seat.

It should be noted that in the embodiments of the present invention, the directional terms “front”, “back”, “left”, “right”, etc. of the base 1200 refer to the “front”, “back”, “left”, “right” directions of the vehicle when the base 1200 is installed on the vehicle seat. And in the figures, arrows F2 and B2 are configured to illustrate the “front” and “back” directions of the base 1200, as well as arrows L2 and R2 are configured to illustrate the “left” and “right” directions of the base 1200. These directional terms are provided for clarity purpose of the embodiments of the present invention, while not intended to improperly limit the scope of protection of the present invention.

Referring to FIG. 1, the infant basket 1100 is mounted on the base 1200 in a backward manner, with the sight line of child sitting in the infant basket 1100 facing the rear of the vehicle. It can be understood that the front, back, left, and right directions of the infant basket 1100 installed on the base 1200 in a backward manner are opposite to those of the base 1200.

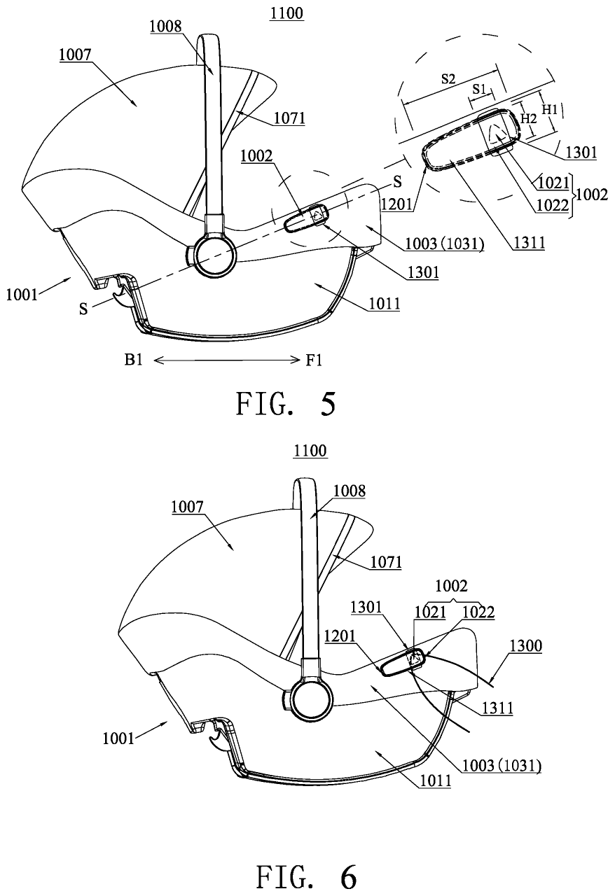

Further referring to FIG. 1, the side portion 1001a of the infant basket 1100 is provided with an engaging member 1002 and a cover member 1311. More specifically, the engaging member 1002 and the cover member 1311 are located on the outer sides of the left and right sides of the infant basket 1100. In FIG. 1, the portion of the engaging member 1002 covered by the cover member 1311 is indicated by dashed lines. Referring to the top view of the infant basket 1100 shown in FIG. 4, the engaging member 1002 defines a slot structure 1020 for engaging with an external safety belt (see FIG. 6, for example, a safety belt for an aircraft seat, hereinafter referred to as the safety belt 1300). The slot structure 1020 has an engaging opening 1201 for the safety belt to enter or leave the slot structure 1020. The cover member 1311 has a first working mode and a second working mode. In the first working mode, the cover member 1311 covers at least a portion of the engaging member 1002, and more specifically, covers at least a portion of the engaging opening 1201, so that the engaging opening 1201 is completely or partially covered by the cover member 1311, thereby restricting the external safety belt (the safety belt of the vehicle seat, hereinafter referred to as the vehicle safety belt) from entering the slot structure 1020, effectively avoiding incorrect engagement between the vehicle safety belt and the slot structure 1020 (as shown in FIG. 5). In the second working mode, the cover member 1311 releases the cover of the engaging opening 1201 and allows the seat belt to enter the slot structure 1020. The safety belt 1300 that passes through the slot structure 1020 can easily fix the infant basket 1100 to the aircraft seat (as shown in FIG. 6).

The infant basket 1100 provided in the embodiments of the present invention can be switched to the first or second using mode by switching the cover member 1311 to the first or second working mode. The first working mode of the cover member 1311 corresponds to the first using mode of the infant basket 1100, and the second working mode of the cover member 1311 corresponds to the second using mode of the infant basket 1100. In the first using mode, the infant basket 1100 is suitable for use in vehicles and can be installed on the vehicle seat by the base 1200. At this time, the cover member 1311 in the first working mode can prevent the vehicle safety belt from entering the slot structure 1020 through the engaging opening 1201, effectively avoiding the user's incorrect installation of the vehicle safety belt into the slot structure 1020 and causing the fixation failure of the base 1200. In the second using mode, the infant basket 1100 is suitable for use in an aircraft, for example, directly placed on the aircraft seat (not shown in the Figures). At this time, the cover member 1311 in the second working mode releases the cover of the engaging opening 1201 and allows the safety belt to enter the slot structure 1020. The safety belt passes through the slot structure 1020 and reliably installs the infant basket 1100 on the aircraft seat.

Referring to FIGS. 2, 4, and 5 for the exemplary embodiments of the engaging member 1002. The engaging member 1002 can include a connection portion 1021 and an extension portion 1022. The connection portion 1021 extends outward from the side portion 1011 of the body 1001. More specifically, the connection portion 1021 can extend laterally from the outer side of the side wing 1015 (such as in the R1-L1 direction in FIG. 4) outward. The extension portion 1022 extends from the outer end 1211 of the connection portion 1021 in the forward and backward directions of the infant basket 1100 (the B1-F1 direction as shown in FIG. 4). The extension direction S-S of the extension portion 1022 is not parallel or overlapping with the extension direction T-T of the connection portion 1021, that is, an angle (such as a 90 degree angle) is formed between the extension direction S-S and the extension direction T-T. Referring to FIG. 5, the extension direction S-S of the extension portion 1022 is not limited to the forward and backward directions parallel to the horizontal plane. In some embodiments, the extension direction S-S of the extension portion 1022 may be inclined in the forward and backward directions relative to the horizontal plane. In some embodiments, the engaging member 1002 can be integrally formed with the plastic shell of the body 1001. In some embodiments, the engaging member 1002 may be installed onto the body 1001, for example, through a fastener (such as a screw).

Referring to FIG. 4, the connection portion 1021, the extension portion 1022, and the side portion 1011 of the body 1001 jointly define the slot structure 1020. The engaging opening 1201 of the slot structure 1020 is formed between one end of the extension portion 1022 away from the connection portion 1021 and the side portion 1011 of the body 1001. As mentioned above, the engaging opening 1201 provides for the safety belt 1300 to enter or leave the slot structure 1020, allowing the infant basket 1100 to be fixed on or removed from the aircraft seat.

Of course, the implementation of the engaging member 1002 is not limited to the above examples, as long as it can form the slot structure 1020 for engaging with the safety belt and having the engaging opening 1201. For example, in some alternative embodiments, the extension direction S-S of the extension portion 1022 may be perpendicular to the horizontal plane. In addition, although the extension direction T-T of the connection portion 1021 and the extension direction S-S of the extension portion 1022 in FIGS. 4 and 5 are generally perpendicular and form a 90 degree angle, in some alternative embodiments, an obtuse angle or an acute angle can be formed between the extension direction T-T and the extension direction S-S. In addition, in some alternative embodiments, the engaging member 1002 may include a base portion (not shown in the Fig.) connected to the connection portion 1021 and opposite to the extension portion 1022. The base portion is installed on the side portion 1011 of the body 1001. The base portion, connection portion 1021, and extension portion 1022 jointly define the slot structure 1020, and the engaging opening 1201 of the slot structure 1020 is formed between one end of the extension portion 1022 away from the connection portion 1021 and the base portion. In addition, in some alternative embodiments, the engaging member 1002 may be a hollow closed structure, such as a closed annular structure (not shown in the Fig.), the hollow channel of the closed annular structure forms the slot structure 1020, and the end of the hollow channel forms the engaging opening 1201.

Referring to FIGS. 1, 5, and 6, exemplary embodiments of the cover member 1311 are shown. In FIG. 5, the portion of the engaging member 1002 covered by the cover member 1311 is indicated by dashed lines. In this implementation, the cover member 1311 includes, for example, the seat cloth 1003, which may include a skirt edge 1031 folded from the upper edge of the side wing 1015 of the body 1001 towards the outer side of the body 1001. The skirt edge 1031 is configured to cover the engaging member 1002 and the engaging opening 1201. The cover member 1311 (more specifically, the skirt edge 1031) is provided with a first opening 1301 at the position corresponding to the engaging member 1002. When the cover member 1311 is in the first working mode, the skirt edge 1031 of the seat cloth 1003 covers the engaging opening 1201 to restrict the vehicle safety belt from entering the slot structure 1020. It can be understood that when the cover member 1311 is in the first working mode, the skirt edge 1031 is supported by the extension portion 1022 of the engaging member 1002 and away from the side portion 1011 of the body 1001. Referring to FIG. 6, when the cover member 1311 needs to switch to the second working mode, the extension portion 1022 of the engaging member 1002 is suitable to pass through the first opening 1301 and expose the engaging opening 1201 outside the cover member (more specifically, the skirt edge 1031), and the safety belt 1300 can directly enter the slot structure 1020 from the engaging opening 1201 and engage with the engaging member 1002 to fix the infant basket 1100 on the aircraft seat. It can be understood that when the cover member 1311 is in the second working mode, the skirt edge 1031 is closer to the outer side of the side portion 1011 of the body 1001 relative to the extension portion 1022.

It can be understood that when the cover member 1311 is in the first working mode, the first opening 1301 deviates from the engaging opening 1201, and the first opening 1301 is closer to the connection portion 1021, for example, relative to the engaging opening 1201, so that the vehicle safety belt cannot directly enter the engaging opening 1201 through the first opening 1301. In some embodiments, the first opening 1301 may be provided at a position, for example, corresponding to the connection portion 1021. When the cover member 1311 switches to the second working mode, the engaging member 1002 passes through the first opening 1301. When the cover member 1311 is in the second working mode, the first opening 1301 is, for example, sleeved on the connection portion 1021. In some embodiments, the skirt edge 1031 may be, for example, made of elastic fabric with a significant amount of elastic deformation, such that the first opening 1301 can easily approach the engaging opening 1201, so that the extension portion 1022 of the engaging member 1002 can pass through the first opening 1301.

Refer to FIG. 5 again. In some embodiments, the first opening 1301 is, for example, a hole has a substantial rectangular shape. In the extension direction of the engaging member 1002, more specifically, in the extension direction S-S of the extension portion 1022 of the engaging member 1002, the dimension S1 of the first opening 1301 is, for example, smaller than the dimension S2 of the engaging member 1002 in this direction. In the height direction perpendicular to the extension direction S-S of the engaging member 1002, the dimension H1 of the first opening 1301 is, for example, greater than the dimension H2 of the engaging member 1002 in this direction. This facilitates the engaging member 1002 to thread out from the first opening 1301 along the extension direction S-S. Of course, the implementation of the first opening 1301 is not limited to the implementation shown in FIG. 5, as long as the engaging member 1002 is allowed to extend as needed.

In addition, in some embodiments not shown, the first opening 1301 is, for example, a slit, which can extend along the extension direction S-S of the engaging member 1002. The dimension of the slit is, for example, close to the dimension S2 of the engaging member 1002 in this direction, and the dimension of the slit in the height direction perpendicular to the extension direction S-S is, for example, much smaller than the dimension H2 of the engaging member 1002 in this direction. In some embodiments, the slit may extend, for example, along the height direction perpendicular to the extension direction S-S, as long as the slit allows the engaging member 1002 to pass through and expose the engaging opening 1201. In some embodiments, the cover member 1311 (more specifically, the skirt edge 1031) can be made of elastic material, allowing the first opening 1301 to be elastically enlarged. To prevent the engaging member 1002 from accidentally passing through the slit, the seat cloth 1003 can further be equipped with a sealing member for sealing the slit. For example, the sealing member can use components such as Velcro, zipper, snap-fastener, button, etc. When the cover member 1311 is in the first working mode, the sealing member closes the slit, so that the engaging member 1002 cannot pass through the slit and is covered by the skirt edge 1031, and the vehicle safety belt cannot enter the slot structure 1020. When the cover member 1311 is in the second working mode, the sealing member opens the slit, and the engaging member 1002 can pass through the slit to expose the engaging opening 1201 outside the skirt edge 1031. The safety belt can enter the slot structure 1020 through the engaging opening 1201 and engage with the engaging member 1002 to fix the infant basket 1100 on the aircraft seat.

In the above embodiments, taking the example of the cover member 1311 including the seat cloth 1003, in some alternative embodiments, the cover member 1311 may not include the seat cloth 1003. For example, the cover member 1311 may be a fabric connected to the seat cloth 1003, the fabric is provided, for example, on the outer side of the seat cloth 1003 and may have the first opening 1301 mentioned above. The cover member 1311 can also be detachably connected to the body 1001 and/or the seat cloth 1003 through any suitable positioning structure. The cover member 1311 made of this fabric can cover the engaging opening 1201 to prevent the vehicle safety belt from entering the slot structure 1020, and the engaging member 1002 can thread out from the first opening 1301 to expose the engaging opening 1201 outside the cover member 1311 to allow the safety belt 1300 to enter the slot structure 1020.

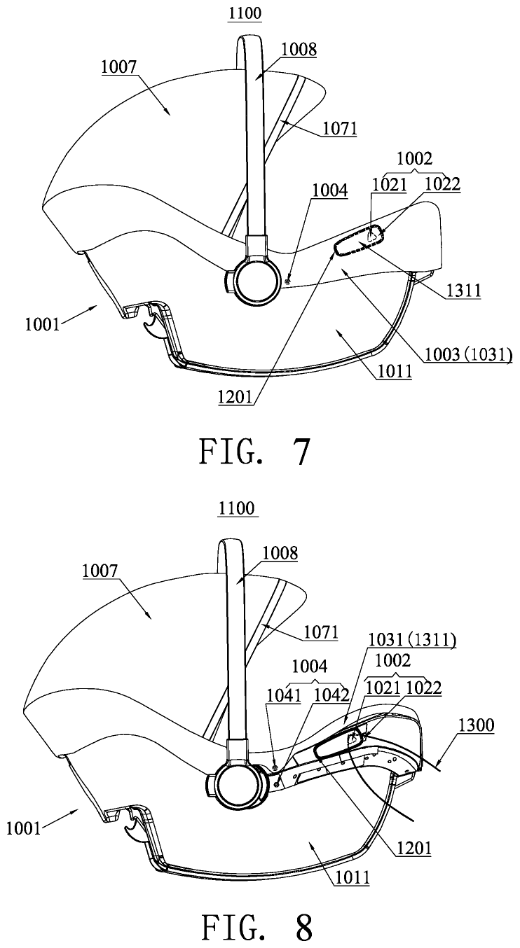

FIGS. 7 and 8 illustrate another exemplary embodiment of the cover member 1311, which is a variant of the cover member 1311 shown in FIGS. 5 and 6. Specifically, the seat cloth 1003 includes, for example, a skirt edge 1031, at least a portion of which forms the cover member 1311, and the cover member 1311 does not have the first opening 1301. Referring to FIG. 7, when the cover member 1311 is in the first working mode, the skirt edge 1031, for example, partially covers the engaging member 1002 and the engaging opening 1201, and the vehicle safety belt cannot enter the slot structure 1020. In FIG. 7, the portion of the engaging member 1002 covered by the cover member 1311 is indicated by dashed lines. A first positioning structure 1004 can be provided between the seat cloth 1003 and the body 1001. More specifically, the first positioning structure 1004 can be provided between the skirt edge 1031 and the side portion 1011 of the body 1001. When the cover member 1311 is in the first working mode, the seat cloth 1003 is detachably connected to the body 1001 through the first positioning structure 1004. Referring to FIG. 8, when the cover member 1311 needs to switch to the second working mode, the first positioning structure 1004 releases the positioning of the seat cloth 1003, allowing the skirt edge 1031 to move upwards and expose the engaging opening 1201. The safety belt 1300 can enter the slot structure 1020 through the engaging opening 1201 and engage with the engaging member 1002 to fix the infant basket 1100 to the aircraft seat.

Referring to FIG. 8, in some embodiments, the first positioning structure 1004 may include a first positioning member 1041 installed on the skirt edge 1031 and a second positioning member 1042 installed on the side portion 1011 (more specifically, the outer surface of the side portion 1011) of the body 1001. The first positioning member 1041 and the second positioning member 1042 may be, for example, matched snap-fasteners or other suitable components.

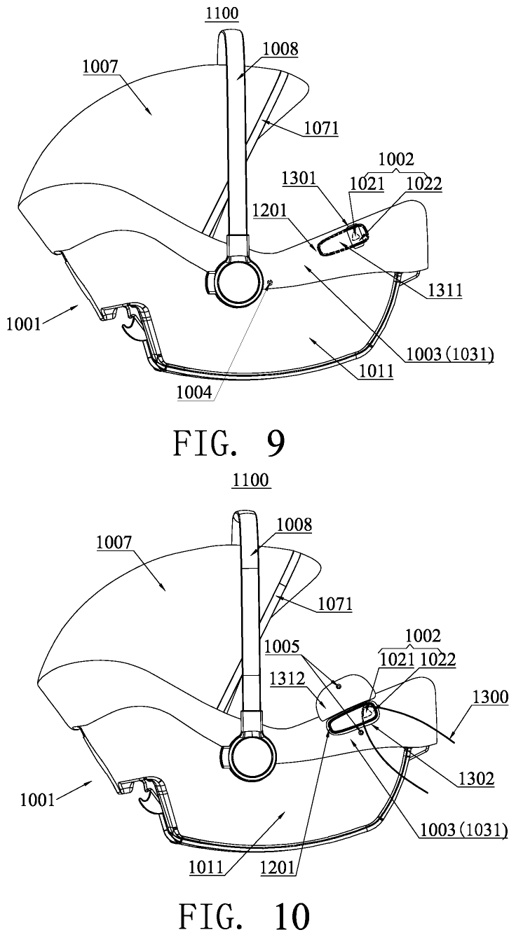

FIG. 9 illustrates another exemplary embodiment of the cover member 1311, which is a variant of the cover member 1311 shown in FIGS. 5 to 8. In FIG. 9, the portion of the engaging member 1002 covered by the cover member 1311 is indicated by dashed lines. Specifically, the seat cloth 1003 includes, for example, the skirt edge 1031, at least a portion of the skirt edge 1031 serves as the cover member 1311, and the cover member 1311 has a first opening 1301. The first positioning structure 1004 can be provided between the seat cloth 1003 and the body 1001. More specifically, the first positioning structure 1004 can be provided between the skirt edge 1031 and the side portion 1011 of the body 1001. When the cover member 1311 is in the first working mode, the cover member 1311 covers the engaging opening 1201 as shown in FIG. 5, and the skirt edge 1031 is detachably connected to the side portion of the body 1001 through the first positioning structure 1004. When the cover member 1311 needs to switch to the second working mode, the first positioning structure 1004 releases the positioning of the skirt edge 1031, allowing the skirt edge 1031 to easily move forward and backward, allowing the extension portion 1022 of the engaging member 1002 to easily pass through the first opening 1301 and expose the engaging opening 1201 outside the skirt edge 1031. When the engaging opening 1201 is exposed outside the skirt edge 1031, the skirt edge 1031 can be reconnected with the side portion 1011 of the body 1001 through the first positioning structure 1004, thereby fixing the position of the skirt edge 1031.

FIG. 10 illustrates another exemplary embodiment of the cover member. Specifically, the seat cloth 1003 includes, for example, the skirt edge 1031, the skirt edge 1031 is provided with a second opening 1302, and the engaging member 1002 is threaded out from the second opening 1302. The dimension of the second opening 1302 is, for example, larger than that of the engaging member 1002, and the skirt edge 1031 can be attached to the outer side of the side portion 1011 of the body 1001. The cover member includes a movable cover 1312 connected to the seat cloth 1003. When the cover member is in the first working mode, the movable cover 1312, for example, cover the second opening 1302 or fully cover the engaging member 1002, and the movable cover 1312 can be connected to the seat cloth 1003 through the second positioning structure 1005, so that the vehicle safety belt cannot enter the slot structure 1020. The second positioning structure 1005, for example, can use components such as Velcro, zipper, snap-fastener, button, etc. When the cover member needs to switch to the second working mode, the second positioning structure 1005 releases the positioning of the movable cover 1312 to allow the movable cover 1312 to move and expose the engaging member 1002. The safety belt can enter the slot structure 1020 through the engaging opening 1201 and engage with the engaging member 1002.

Referring to FIG. 10, in some embodiments, a portion of the edge of the movable cover 1312 is connected to the skirt edge 1031 of the seat cloth 1003, for example, by sewing. In some embodiments not shown, the movable cover 1312 can, for example, be detachably connected to the seat cloth 1003, and can be removed from the seat cloth 1003 when the cover member needs to switch to the second working mode. In some embodiments, the movable cover 1312 may be part of the seat cloth 1003, or the movable cover 1312 may be made of plastic or metal.

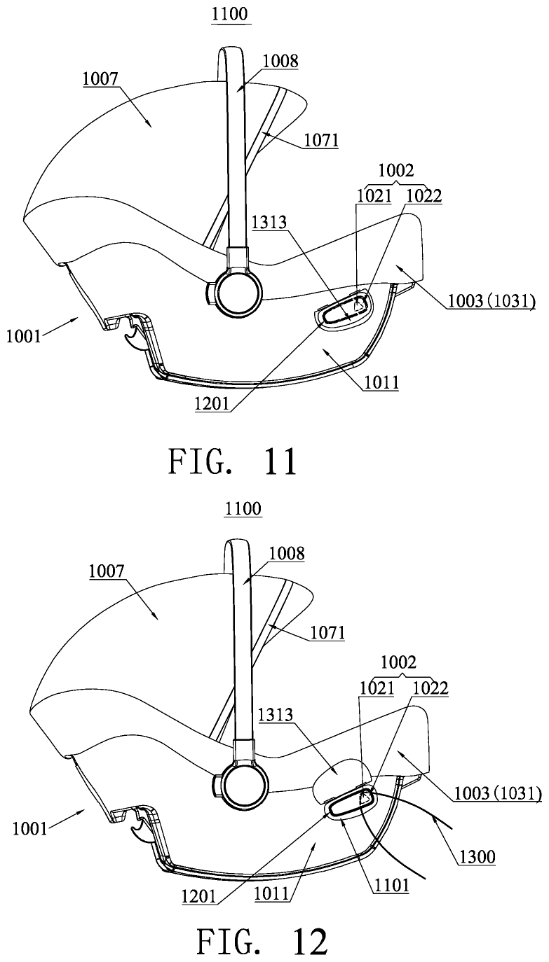

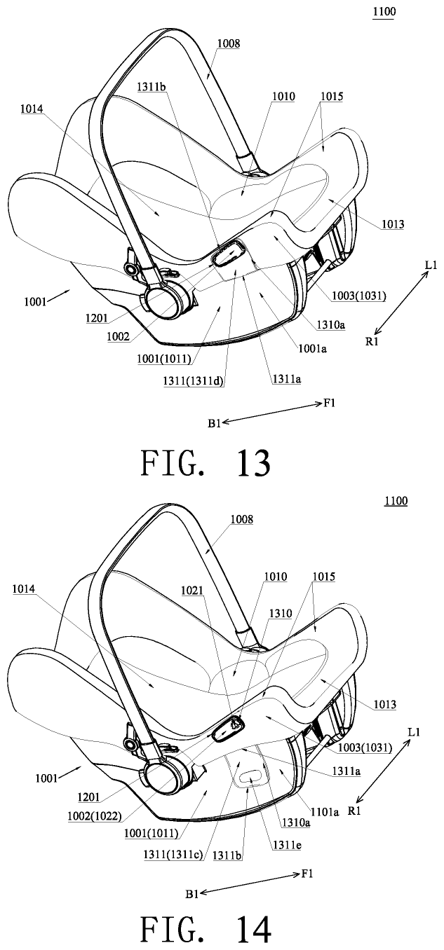

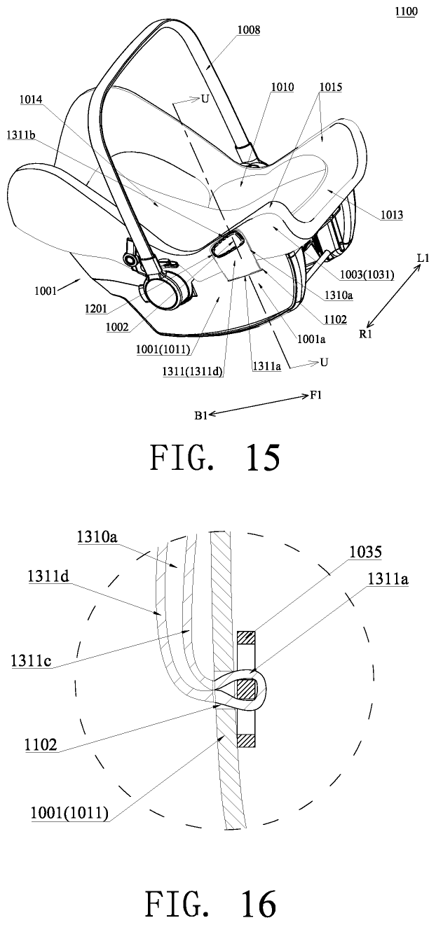

FIGS. 11 and 12 illustrate another exemplary embodiment of the cover member. In FIG. 11, the portion of the engaging member 1002 covered by the cover member is indicated by a dashed line. Specifically, the side portion 1011 of the body 1001 is provided with a recess 1101, which is located, for example, on the outer side of the side portion 1011. The engaging member 1002 is located within the recess 1101, and the engaging member 1002 itself or together with the body 1001 defines a slot structure 1020 with the engaging opening 1201. The cover member, for example, includes a cover body 1313. When the cover member is in the first working mode, the cover body 1313 is placed on the recess 1101 and covers the engaging member 1002, so that the vehicle safety belt cannot enter the slot structure 1020. When the cover member needs to switch to the second working mode, the cover body 1313 opens the recess 1101 to expose the engaging member 1002, and the safety belt can enter the slot structure 1020 through the engaging opening 1201 to engage with the engaging member 1002, to fix the infant basket 1100 to the aircraft seat. In some embodiments, the cover body may be pivotally connected to the body 1001. In some embodiments, the cover body 1313 may be part of the seat cloth 1003, or the cover body 1313 may be made of plastic or metal.

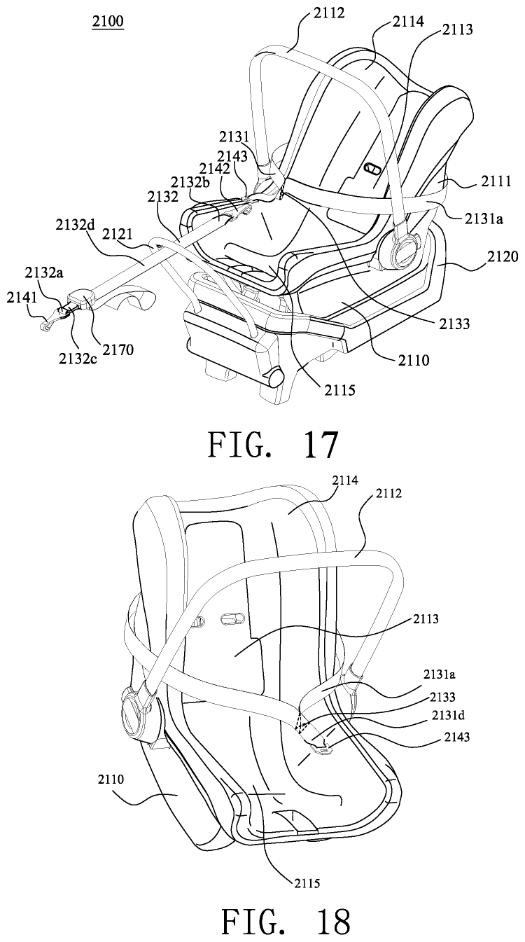

FIGS. 13 and 14 illustrate another exemplary embodiment of the cover member. The cover member 1311, for example, is a strap made of fabric, including a first surface 1311c and a second surface 1311d in opposition. The edges of the first surface 1311c and the second surface 1311d are sewn together, forming an accommodating space 1310a between the two. The contours of the accommodating space 1310a are shown as dashed lines in FIGS. 13 and 14. Of course, in other embodiments, the material of the cover member 1311 is not limited to fabric, and its shape is not limited to strap.

The first end 1311a of the cover member 1311 is a fixed end, which can be connected to the skirt edge 1031 of the seat cloth 1003 or the body 1001 in any suitable way. In this embodiment, the first end 1311a of the cover member 1311 is sewn together with the skirt edge 1031, for example. In other embodiments, the first end 1311a of the cover member 1311 may be connected to the side portion 1011 or bottom of the body 1001, for example.

The second end 1311b of the cover member 1311 is a free end. Referring to FIG. 14, when the cover member 1311 is in the second working mode, the engaging member 1002 is located above the first end 1311a of the cover member 1311, and the second end 1311b of the cover member 1311 naturally droops and is located below the first end 1311a. At this point, the cover member 1311 is separated from the second engaging member 1002, and the first surface 1311c of the cover member 1311 facing away from the body 1001 is visible, while the second surface 1311d facing the body 1001 is invisible. The safety belt can be easily engaged to the engaging member 1002 through the engaging opening 1201 to secure the infant basket 1100 to the aircraft seat.

Further referring to FIG. 14, a third opening 1311e is provided on the first surface 1311c, the third opening 1311e is connected to the accommodating space 1310a, and the third opening 1311e is provided close to the second end 1311b of the cover member 1311. When it is necessary to switch the cover member 1311 from the second working mode to the first working mode, flip the cover member 1311 upwards relative to its first end 1311a, so that the first surface 1311c is close to the engaging member 1002. Referring to FIG. 13, at this point, the first surface 1311c facing the body 1001 is invisible, and the second surface 1311d facing away from the body 1001 is visible. When the cover member 1311 is flipped upwards into place, the extension portion 1022 of the engaging member 1002 can enter the accommodating space 1310a through the third opening 1311e. At this point, the cover member 1311 can cover at least a portion of the engaging opening 1201, thereby limiting the engagement of the vehicle safety belt with the engaging member 1002.

In some embodiments, the dimension of the third opening 1311e may be smaller than the dimension of the outer contour of the extension portion 1022 of the engaging member 1002. In this way, after the extension portion 1022 enters the accommodating space 1310a, the third opening 1311e is clamped with the extension portion 1022, which can prevent the extension portion 1022 from accidentally sliding out of the third opening 1311e. In some embodiments, the third opening 1311e can be pushed apart during the process of the extension portion 1022 entering the accommodating space 1310a, and returns to its initial shape after the extension portion 1022 enters the accommodating space 1310a.

FIG. 15 illustrates another exemplary embodiment of the cover member, which is a variant of the cover member shown in FIGS. 13 and 14, with the main difference being the fixing method of the first end 1311a of the cover member 1311. In this implementation, the side portion 1011 of the body 1001 is provided with a narrow limit hole 1102, and the first end 1311a of the cover member 1311 is positioned after penetrating into the limit hole 1102.

Referring to FIG. 16, in some embodiments, the first end 1311a of the cover member 1311 is provided with a limit member 1035 that is clamped to the limit hole 1102. The limit member 1035 may be, but not limited to, a sliplok buckle. In some alternative embodiments, the first end 1311a of the cover member 1311 can be formed by the cover member 1311 itself through sewing, for example, to form a limit member 1035 that can be clamped with the limit hole 1102.

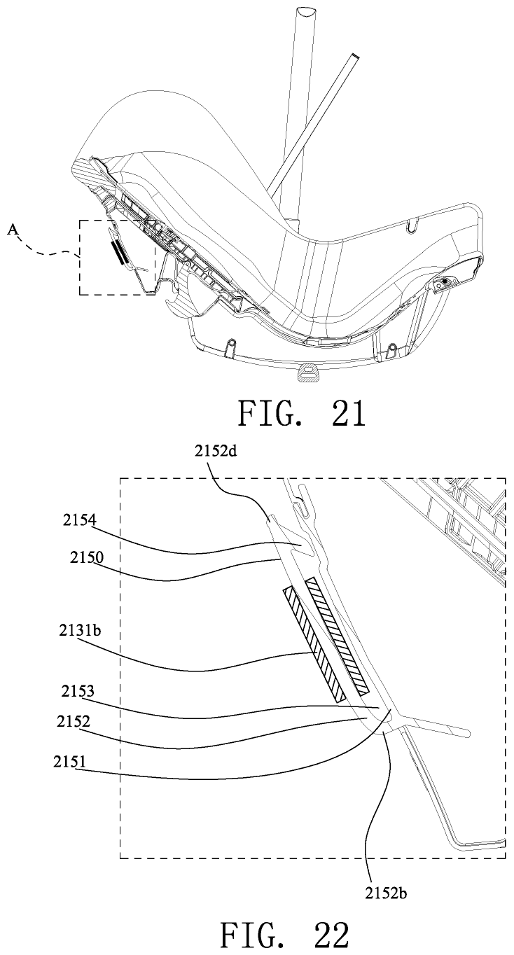

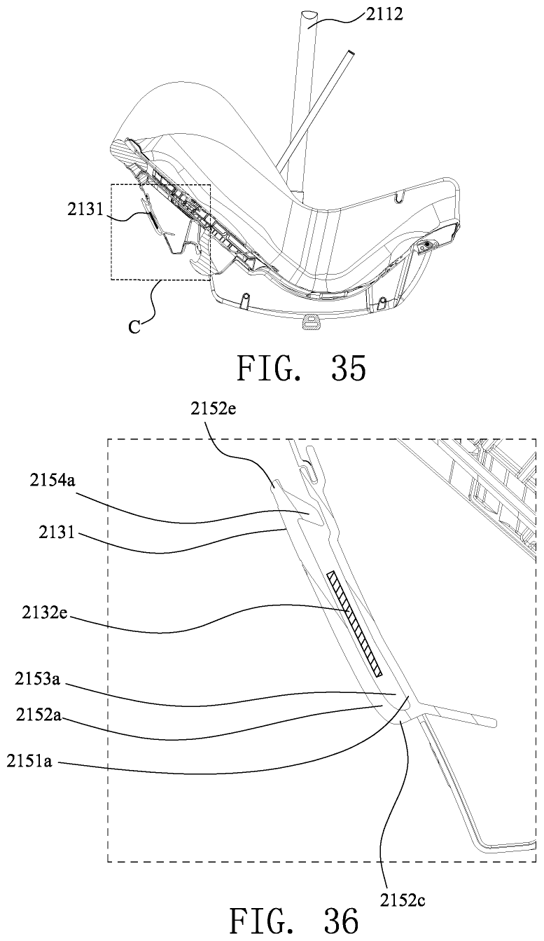

The embodiments of FIGS. 17 to 37 of the present application improve the problem of the top tether system being fixedly connected to the seat body 2110, causing the top tether system to increase the weight of the seat body 2110, making it inconvenient for the seat body 2110 to be disassembled from the base 2120 and used separately.

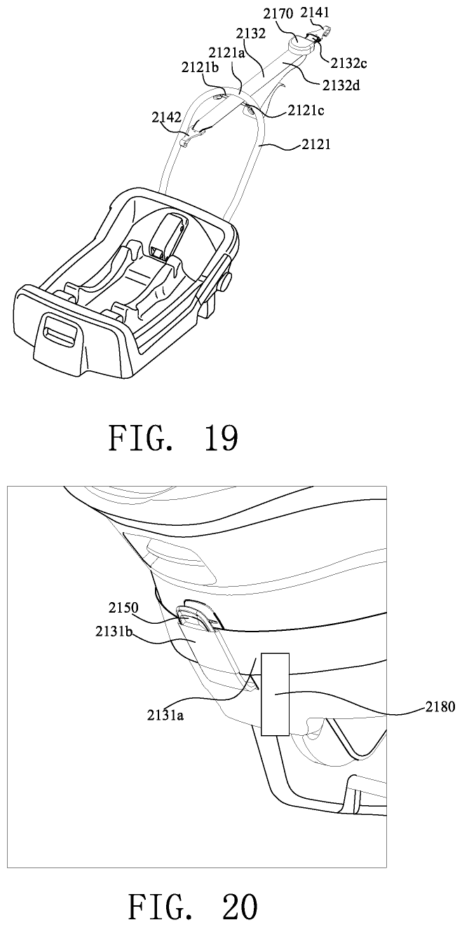

FIG. 17 shows a perspective view of an embodiment of the child safety seat 2100 according to the present invention. According to the present invention, the child safety seat 2100 is connected to the vehicle (not shown) using a top tether system. The child safety seat 2100 includes a top tether system, a seat body 2110 and base 2120 that are detachably connected to each other. The seat body 2110 can support children, and the base 2120 can be connected to the vehicle. The bottom of the seat body 2110 can be installed on the base 2120, or can be disassembled and used separately from the base 2120, as shown in FIG. 17. The seat body 2110 is equipped with a handle 2112, the seat body 2110 can be used as an infant basket alone. FIG. 18 shows the state of the seat body 2110 when the seat body 2110 of the child safety seat 2100 in FIG. 17 leaves the base 2120, and FIG. 19 shows the state of the base 2120 after the seat body 2110 of the child safety seat 2100 in FIG. 17 is removed.

As shown in FIGS. 17 and 18, the seat body 2110 includes a backrest portion 2113 for children to lean against, a sitting portion 2115 to support children's hips, and side wings 2114 connected to the backrest portion 2113 and protecting children's sides. The seat body 2110 has a support surface that supports children and a back 2111 that is away from the children. In some embodiments, when the seat body 2110 is connected to the base 2120 and installed and connected to the vehicle, the back 2111 of the seat body 2110 may face the seat back of the vehicle (not shown), or the support surface of the seat body 2110 may face the seat back of the vehicle. It should be noted that the installation direction shown in FIG. 17 is that the support surface of the seat body 2110 faces towards the seat back of the vehicle. As shown in FIG. 19, the base 2120 includes a top rod structure for abutting the vehicle, the top rod structure is configured to abut the seat back of the vehicle.

As shown in FIGS. 17 and 19, the top tether system comprises: a detachable first part 2131 and a second part 2132, wherein at least one of the first part 2131 and the second part 2132 forms a flexible strap structure, the first part 2131 is configured to connect the seat body 2110, and the second part 2132 is configured to connect the vehicle; the first part 2131 is restricted from detaching from the seat body 2110, while the second part 2132 is configured to connect to the base 2120 and is restricted from detaching from the base 2120. In this embodiment, as shown in FIG. 17, both the first part 2131 and the second part 2132 form a flexible strap structure.

As shown in FIG. 17, the second part 2132 has a first end 2132a and a second end 2132b, and the top tether system further includes a first connecting member 2141 and a second connecting member 2142. The first connecting member 2141 is provided at the first end 2132a of the second part 2132 to connect the vehicle, and the second connecting member 2142 is provided at the second end 2132b of the second part 2132 and detachably connected to the first part 2131. Furthermore, the top tether system further includes a third connecting member 2143, which is provided in the first part 2131 and configured to mate with the second connecting member 2142.

Specifically, one of the second connecting member 2142 and the third connecting member 2143 has a hook, and the other of the second connecting member 2142 and the third connecting member 2143 has a connecting hole. Specifically, as shown in FIG. 17, the second connecting member 2142 in this embodiment is a hook, and the third connecting member 2143 has a connecting hole. The hook is snap fitted with the connecting hole to facilitate quick connection or disassembly between the second part 2132 and the first part 2131. In other embodiments, the hook and the connecting hole can be interchanged, that is, the second connecting member 2142 has a connecting hole, and the third connecting member 2143 is the hook. It should be noted that in some embodiments, the first connecting member 2141, the second connecting member 2142, and the third connecting member 2143 can all be selectively set. For example, if the third connecting member 2143 is not set, the first part 2131 is a flexible strap structure, being tied or passed through and clamped to the second connecting member 2142.

That is to say, when the child safety seat according to the present invention is used in a vehicle, the first connecting member 2141 is connected to the corresponding fixing device of the vehicle, the second connecting member 2142 is connected to the third connecting member 2143, and the first part 2131 is fixedly connected to the seat body 2110. The length of the second part 2132 is adjusted by the adjusting member 2170 provided in the second part 2132 (to be used in different vehicle models), so that the top tether system fixes the child safety seat 2100 to the vehicle.

As shown in FIGS. 17 and 18, the first part 2131 has a surrounding portion 2131a, which surrounds and is fixedly connected to the back 2111 of the seat body 2110. Specifically, the surrounding portion 2131a of this embodiment is fixedly connected to the back 2111 of the backrest portion 2113 of the seat body 2110. In use, the surrounding portion 2131a of the first part 2131 is a closed circular structure, and the first part 2131 further has an extension portion 2131d connected to the surrounding portion 2131a (as shown in FIG. 18), the extension portion 2131d is connected to the second part 2132. That is to say, the surrounding portion 2131a of the first part 2131 is connected to the back 2111 of the backrest portion 2113 of the seat body 2110, and extends towards the front of the two side wings 2114 and the backrest portion 2113, so that the top tether system can firmly fix the seat body 2110 to the vehicle when using the child safety seat according to the present invention. In this embodiment, as shown in FIGS. 17 to 19, the first part 2131 and the second part 2132 are both woven straps. The first part 2131 forms the extension portion 2131d and the closed circular structure surround part 2131a by sewing one end of a woven strap to the stitching position 2133 adjacent to the other end (i.e. the end of the extension portion 2131d).

Preferably, the surrounding portion 2131a of the first part 2131 is connected to the back 2111 of the backrest portion 2113 of the seat body 2110 at a substantially central position. In the situation that the top tether system connects the child safety seat 2100 to the vehicle, the connection point between the third connecting member 2143 and the second connecting member 2142 is located on the substantially longitudinal symmetry plane of the seat body 2110, so that when using the child safety seat according to the present invention in the vehicle, the top tether system can evenly apply force to fix the seat body 2110 to the vehicle.

FIG. 18 shows the state of the seat body 2110 when the seat body 2110 of the child safety seat 2100 in FIG. 17 leaves the base 2120, and FIG. 19 shows the state of the base 2120 after the seat body 2110 of the child safety seat 2100 in FIG. 17 is removed. When the first part 2131 and the second part 2132 of the top tether system of the child safety seat 2100 according to the present invention are disassembled from each other, the seat body 2110 (infant basket) can be taken out separately (as shown in FIG. 18), and the child safety seat 2100 can be fixed to the vehicle when the first part 2131 and the second part 2132 of the top tether system are connected to each other. After the seat body 2110 of the child safety seat according to the present invention is removed, the first part 2131 is restricted from detaching from the seat body 2110 and remaining on the seat body 2110 (as shown in FIG. 18), and the second part 2132 is restricted from detaching from the base 2120 and remaining on the base 2120 (as shown in FIG. 19) to avoid losing the first part 2131 and the second part 2132. Moreover, since the second part 2132 remains on the base 2120 instead of being lifted with the seat body 2110, the weight of the seat body 2110 can be reduced, making it convenient for the separate use of the seat body 2110.

As shown in FIG. 19, furthermore, the top tether system further comprises the adjusting member 2170 connected to the second part 2132, the adjusting member 2170 is configured to adjust the length of the second part 2132. In this embodiment, the second part 2132 includes a connecting section 2132c and an adjusting section 2132d, the adjusting member 2170 is connected between the connecting section 2132c and the adjusting section 2132d, the connecting section 2132c is connected between the first connecting member 2141 and the adjusting member 2170, and the adjusting section 2132d is connected between the second connecting member 2142 and the adjusting member 2170. Specifically, one end of the adjustment section 2132d is connected to the second connecting member 2142, the other end of the adjusting section 2132d is passing through and connected to one end of the adjusting member 2170, the other end of the adjusting member 2170 is connected to one end of the connecting section 2132c, and the other end of the connecting section 2132c is connected to the first connecting member 2141. The connecting section 2132c and the adjusting section 2132d can both be woven straps; alternatively, the adjusting section 2132d is a woven strap, while the connecting section 2132c is made of other materials such as plastic or metal.

As shown in FIG. 19, the top rod structure of the base 2120 has the top rod 2121 and the connection portion 2121c, and the top rod 2121 has an abut portion 2121a. The top rod 2121 is approximately in an inverted U-shape, and the legs of the inverted U-shape converge at the top of the inverted U-shape to form the abut portion 2121a. The connection portion 2121c of the top rod structure is adjacent to the abut portion 2121a. Furthermore, the connection portion 2121c is provided on the inner side of the abut portion 2121a, and the two ends of the connection portion 2121c are connected to the opposite sides of the abut portion 2121a (specifically the two bends of the top rod 2121), thereby forming a penetration portion 2121b between the abut portion 2121a and the connection portion 2121c. The second part 2132 is connected to the top rod structure of the base 2120. Specifically, the second part 2132 passes through the penetration portion 2121b between the abut portion 2121a and the connection portion 2121c of the top rod structure of the base 2120 and is restricted from detaching from the penetration portion 2121b (as shown in FIG. 19).

As shown in FIG. 19, the adjusting section 2132d of the second part 2132 is threaded through the penetration portion 2121b, and the adjusting member 2170 and the second connecting member 2142 are both restricted from passing through the penetration portion 2121b (restricted by the abut portion 2121a and the connection portion 2121c) to prevent the second part 2132 from detaching from the base 2120 (the second part 2132 is non-detachably connected to the top rod structure). Of course, in other embodiments, the connecting section 2132c of the second part 2132 may be threaded through the penetration portion, and the adjusting member 2170 and the first connecting member 2141 are both restricted from passing through the penetration portion 2121b (restricted by the abut portion 2121a and the connection portion 2121c) to prevent the second part 2132 from detaching from the base 2120.

In other embodiments, the positions of the connecting section 2132c and the adjusting section 2132d can be interchanged, that is, the connecting section 2132c is connected between the second connecting member 2142 and the adjusting member 2170, the adjusting section 2132d is connected between the first connecting member 2141 and the adjusting member 2170. Similarly, the connecting section 2132c or the adjusting section 2132d can be threaded through the penetration portion 2121b, and the adjusting member 2170 and the first connecting member 2141 or the adjusting member 2170 and the second connecting member 2142 are restricted from passing through the penetration portion 2121b, thereby restricting the second part 2132 from detaching from the base 2120.

In other embodiments, the adjusting member 2170 can also be connected to the first part 2131 (for example, connected to the extension portion 2131d), and the total length of the top tether can be adjusted by adjusting the length of the extension portion 2131d (for use with different vehicle models). At this point, the second part 2132 is connected with the first connecting member 2141 and the second connecting member 2142. Both the first connecting member 2141 and the second connecting member 2142 are restricted from passing through the penetration portion 2121b to prevent the second part 2132 from detaching from the base 2120 (the second part 2132 is non-detachably connected to the top rod structure).

In other embodiments, the top rod structure may not be provided the connection portion 2121c and form a penetration portion 2121b through other means, such as the wall surface of the abut portion 2121a of the top rod structure being penetrated to form a penetration portion 2121b.

As shown in FIG. 20, the top tether system further includes a fixing member 2150 connected to the back 2111 of the backrest portion 2113 of the seat body 2110. The surrounding portion 2131a of the first part 2131 has a first fixing portion 2131b, which is connected in coordination with the fixing member 2150. That is to say, the first fixing portion 2131b of the surrounding portion 2131a of the first part 2131 is connected in coordination with the fixing member 2150 of the back 2111 of the backrest portion 2113 of the seat body 2110, in order to fix the first part 2131 to the back 2111 of the backrest portion 2113 of the seat body 2110.

As shown in FIG. 22, the first fixing portion 2131b of the surrounding portion 2131a of the first part 2131 is in a sleeve shape and is sleeved on the fixing member 2150 of the back 2111 of the backrest portion 2113 of the seat body 2110. Preferably, the first fixing portion 2131b of the surrounding portion 2131a of the first part 2131 is elastic, so that the first fixing portion 2131b can elastically deform and accommodate the fixing member 2150, that is to say, the first fixing portion 2131b is an elastic sleeve for elastic fastening to the fixing member 2150. The first fixing portion 2131b of the surrounding portion 2131a of the first part 2131 can be sewn together with the first part 2131 itself (woven strap); it can also be a portion of woven strap and a portion of extra stitched straps (elastic bands); it can also be that the whole of the first fixing portion 2131b is an additional component sewn to the surrounding portion 2131a of the first part 2131. Preferably, as shown in FIG. 20, the first part 2131 includes an elastic band and a woven strap. The two ends of the elastic band are sewn onto the woven strap, and the upper and lower ends of the elastic band are not closed and form a ring together with a part of the woven strap to form the first fixing portion 2131b of the surrounding portion 2131a.

As shown in FIG. 22, the fixing member 2150 has an installation portion 2151 for installing on the back 2111 of the backrest portion 2113 of the seat body 2110, and a second fixing portion 2152 connected to the installation portion 2151. There is a gap 2153 between the installation portion 2151 and the second fixing portion 2152, and the first fixing portion 2131b is sleeved on the second fixing portion 2152 and partially located in the gap 2153. Specifically, a portion of the woven strap of the surrounding portion 2131a is located in the gap 2153, and the elastic band sewn onto the woven strap is located outside the second fixing portion 2152. The elastic band has the force to tightly fit the first fixing portion 2131b onto the second fixing portion 2152 due to being stretched. One end 2152b of the second fixing portion 2152 of the fixing member 2150 is connected to the installation portion 2151 of the fixing member 2150, and the other end 2152d of the second fixing portion 2152 is suspended to form an opening for the fixing member 2150. There is a blocking portion 2154 at the position corresponding to the opening of the second fixing portion 2152 of the fixing member 2150. The blocking portion 2154 restricts the first fixing portion 2131b from detaching from the second fixing portion 2152 to restrict the first part 2131 from detaching from the seat body 2110. That is to say, when connecting the first fixing portion 2131b and the fixing member 2150, the sleeve shaped (annular) first fixing portion 2131b of the surrounding portion 2131a of the first part 2131 crosses the blocking portion 2154 from the other end 2152d of the second fixing portion 2152 of the fixing member 2150, and is fitted onto the second fixing portion 2152 of the fixing member 2150 through the gap between the blocking portion 2154 and the installation portion 2151. The shape of the blocking portion 2154 (such as the barbed shape shown in FIG. 22) is constructed so that the first fixing portion 2131b of the surrounding portion 2131a of the first part 2131 in a sleeve shape (annular) is easily fitted onto the second fixing portion 2152 of the fixing member 2150 through the gap between the blocking portion 2154 and the installation portion 2151, and is later restricted by the blocking portion 2154 to prevent detachment from the second fixing portion 2152. Of course, the fixing method between the first part 2131 and the seat body 2110 is not limited to this. Even if the first part 2131 is a flexible strap structure, it can be directly fixed to the back 2111 of the seat body 2110 through fasteners such as rivets and screws.

As shown in FIG. 20, the child safety seat 2100 further includes a storage bag 2180 for storing the first part 2131, the storage bag 2180 is connected to the first part 2131 or the seat body 2110. The child safety seat 2100 according to the present invention further comprises a seat cloth provided on the seat body 2110, and the storage bag 2180 can also be connected to the seat cloth. Therefore, when it is necessary to remove the first part 2131 of the top tether system from the child safety seat 2100 (the user intentionally operates to remove the first part 2131 from the seat body 2110, rather than accidentally losing it), the first part 2131 left on the seat body 2110 can be placed in the storage bag 2180 (the surrounding portion 2131a of the first part 2131 can be separated from the seat body 2110 and placed in the storage bag 2180), such that the seat body 2110 will have a neat appearance and convenient for individual use of the seat body 2110. That is to say, after taking out the seat body 2110 separately, the first part 2131 of the top tether system with a flexible strap structure can be stored in the storage bag 2180.

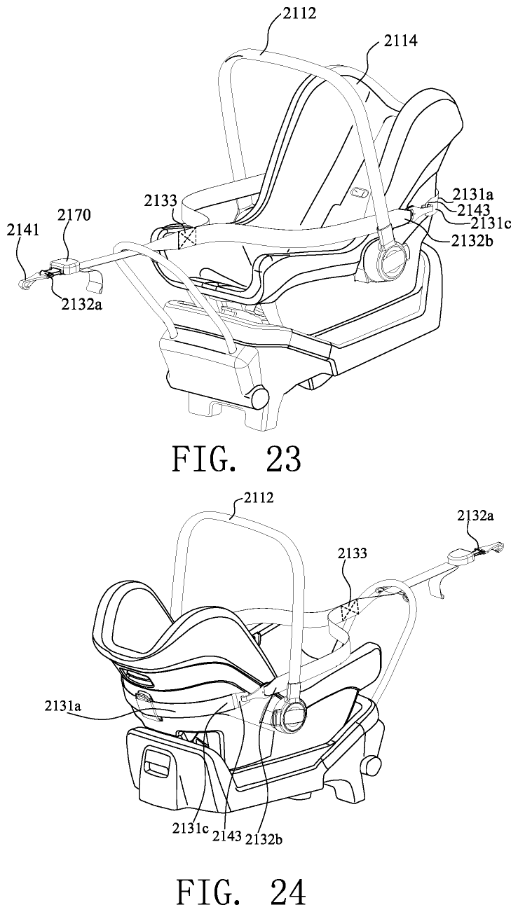

FIG. 23 is a perspective view of the second embodiment of the child safety seat according to the present invention. The main difference from the first embodiment is that the surrounding portion 2131a of the first part 2131 has two free ends 2131c, and the second part 2132 includes a first end 2132a and two second ends 2132b. The first end 2132a is configured to connect the vehicle, and the two free ends 2131c are detachably connected to the two second ends 2132b, respectively. In this embodiment, two third connecting members 2143 are respectively connected to the two free ends 2131c, and the two third connecting members 2143 are detachably connected to the two second connecting members 2142 connected to the two second ends 2132b. Preferably, the two free ends 2131c of the surrounding portion 2131a of the first part 2131 are located approximately in a position of the back 2111 of the backrest portion 2113 of the seat body 2110, which position is the middle of the upper and lower parts of the back 2111, and is symmetrical on both sides of the back 2111 (the backrest portion 2131a of the first part 2131 is arranged around the back 2111 of the backrest portion 2113 of the seat body 2110 and extends to the side wings 2114 on both sides), and the connection points between the two free ends 2131c of the surrounding portion 2131 of the first part 2131 and the two second ends 2132b of the second part 2132 are located approximately in a position, which position is the middle of the upper and lower parts of the back 2111, and is symmetrical on both sides of the back 2111, so that when using the child safety seat according to the present invention in a vehicle, the top tether system can evenly apply force to fix the seat body 2110 to the vehicle. The second part 2132, which has two second ends 2132b and one first end 2132a, is a Y-shaped flexible strap structure as a whole. That is to say, the three branches of the second part 2132 form two second ends 2132b and one first end 2132a, and intersect at the middle intersection point (suture 2133 shown in FIG. 23) to form a Y-shaped structure.

FIG. 24 is another perspective view of the child safety seat 2100 according to FIG. 23, which more clearly illustrates the specific location of the detachable connection between the second end 2132b of the second part 2132 and the surrounding portion 2131a of the first part 2131.

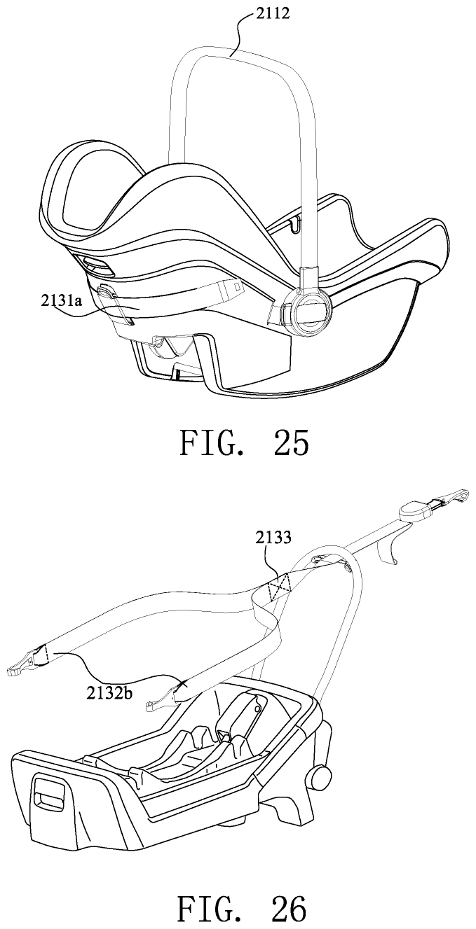

FIG. 25 shows the state of the seat body 2110 when the seat body 2110 of the child safety seat 2100 according to FIG. 23 leaves the base 2120, and FIG. 26 shows the state of the base 2120 after the seat body 2110 of the child safety seat 2100 according to FIG. 23 is removed. After disassembling the first part 2131 and the second part 2132 of the child safety seat 2100 according to the present invention, the seat body 2110 (infant basket) can be taken out separately (as shown in FIG. 25), when the top tether system is connected, the child safety seat 2100 can be connected to the vehicle. In the situation that the seat body 2110 of the child safety seat according to the present invention is removed, the first part 2131 is restricted from detaching from the seat body 2110 and remaining on the seat body 2110 (as shown in FIG. 25), and the second part 2132 is restricted from detaching from the base 2120 and remaining on the base 2120 (as shown in FIG. 26) to avoid losing the top tether system. Moreover, since the second part 2132 remains on the base 2120, the weight of the seat body 2110 (infant basket) can be reduced, making it convenient for the seat body 2110 to be used alone.

It should be noted that the second embodiment also includes an adjusting member 2170, and the second part 2132 can further include an adjusting section 2132d and a connecting section 2132c. The top rod structure also includes a top rod 2121 and a connection portion 2121c. These corresponding structures and the specific way in which the second part 2132 is restricted to the top rod structure are similar to the first embodiment mentioned above, and will not be repeated here. In addition, the second embodiment also has a fixing member 2150 provided on the back 2111 of the seat body 2110, and the connection means between the surrounding portion 2131a and the fixing member 2150 is similar to the first embodiment mentioned above, which will not be repeated here. Similarly, the child safety seat 2100 of the second embodiment can be equipped with a storage bag 2180. After taking out the seat body 2110 separately, the first part 2131 of the top tether system with the flexible strap structure can be stored in the storage bag 2180.

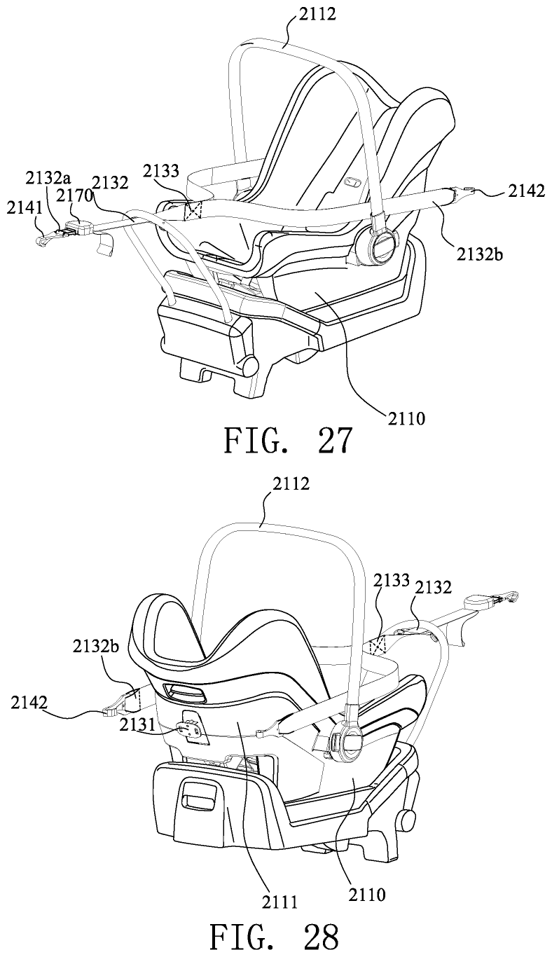

FIG. 27 is a perspective view of a third embodiment of the child safety seat 2100 according to the present invention. FIG. 28 is another perspective view of the child safety seat 2100 according to FIG. 27, which more clearly illustrates the specific positions of the detachable connections between the first part 2131 and the second part 2132. In this embodiment, as shown in FIG. 28, the first part 2131 is a non-flexible structure (such as a metal structure) fixed to the seat body 2110, and the second part 2132 is a flexible strap structure (such as a woven strap).

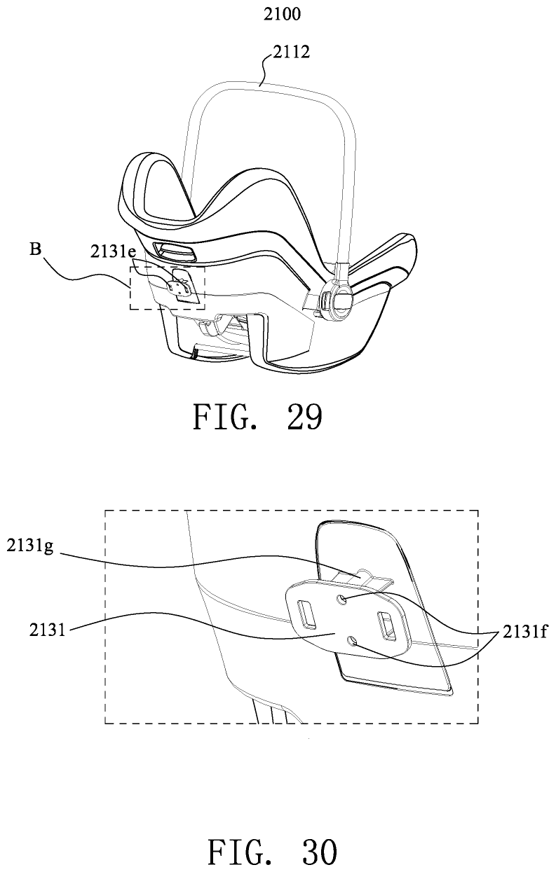

As shown in FIGS. 27 to 28, the second part 2132 has a first end 2132a and a second end 2132b, and the top tether system further comprises: a first connecting member 2141 set at the first end 2132a for connecting the vehicle; the second connecting member 2142, which is provided at the second end 2132b and is detachably connected to the first part 2131. One of the second connecting member 2142 and the first part 2131 has a hook, while the other of the second connecting member 2142 and the first part 2131 has a fixing hole 2131e (as shown in FIG. 29), and the hook is snap fit with the fixing hole 2131e. In this embodiment, the second connecting member 2142 has the hook, and the first part 2131 has the fixing hole 2131e. In other embodiments, the positions of the hook and the fixing hole 2131e can be interchanged.

As shown in FIG. 28, the first part 2131 is fixed on the back 2111 of the backrest portion 2113 of the seat body 2110. The first part 2131 includes two fixing holes 2131e, and the second part 2132 has two second ends 2132b for connecting with two second connecting members 2142 respectively. Each second connecting member 2142 has a hook, and the two hooks and two fixing holes 2131e are connected and clamped one by one correspondence. The first part 2131 is fixed to the seat body 2110 in different implementations: the first part 2131 is installed and fixed to the seat body 2110, for example, the first part 2131 is a metal sheet and installed to the seat body 2110 through fasteners such as rivets or screws; alternatively, the first part 2131 can be fixed to the seat body 2110 through integrated formation.

The second part 2132, which has a first end 2132a and two second ends 2132b, is a Y-shaped flexible strap structure as a whole. That is to say, the three branches of the second part 2132 form the first end 2132a and two second ends 2132b, and intersect at the middle intersection point (stitching position 2133 shown in FIG. 27) to form a Y-shaped structure.

As shown in FIGS. 29 to 30, the first part 2131 is located on the outer side of the back 2111 of the backrest portion 2113 of the seat body 2110. The second part 2132 is configured to connect to the top rod structure of base 2120 for abutting the vehicle. The first part 2131 installed on the seat body 2110 further includes an installation hole 2131f, and fasteners pass through the installation hole 2131 f to connect and fix with an installation column 2131g on the back of the backrest portion 2113 of the seat body 2110, thereby installing the first part 2131 on the seat body 2110. Preferably, the first part 2131 is a fixed iron sheet, which is fixed to the back of the backrest portion 2113 of the seat body 2110 through fasteners; of course, it can also be integrated with the backrest portion 2113 of the seat body 2110 by injection molding, and then reinforced iron sheets or local thickening treatment can be set in its fixing hole 2131e to ensure its strength is sufficient to connect with the second connecting member 2142 to firmly fix the child safety seat 2100 according to the present invention to the vehicle. It should be noted that the first part 2131 is fixed to the outer side of the back 2111 of the backrest portion 2113 of the seat body 2110 through separate installation or integrated formation, so that the top tether system can be applied without damaging the rigidity of the seat body 2110 (for child protection performance).

Preferably, the first part 2131 installed on the seat body 2110 is located at the approximate center of the back 2111 of the backrest portion 2113 of the seat body 2110, and the connection points between the two second connecting members 2142 and the two fixing holes 2131e of the first part 2131 are located in the approximate middle and symmetrical position of the back 2111 of the backrest portion 2113 of the seat body 2110, so that when using the child safety seat according to the present invention in the vehicle, the top tether system can evenly apply force to fix the seat body 2110 to the vehicle. The middle intersection point in the Y-shaped structure is formed at the intersection of the three branches of the second part 2132. When the top tether system is connected to the vehicle for use, the middle intersection point is also located in the approximate longitudinal symmetry plane of the seat body 2110, so that the top tether system can evenly apply force to fix the seat body 2110 to the vehicle when using the child safety seat according to the present invention.

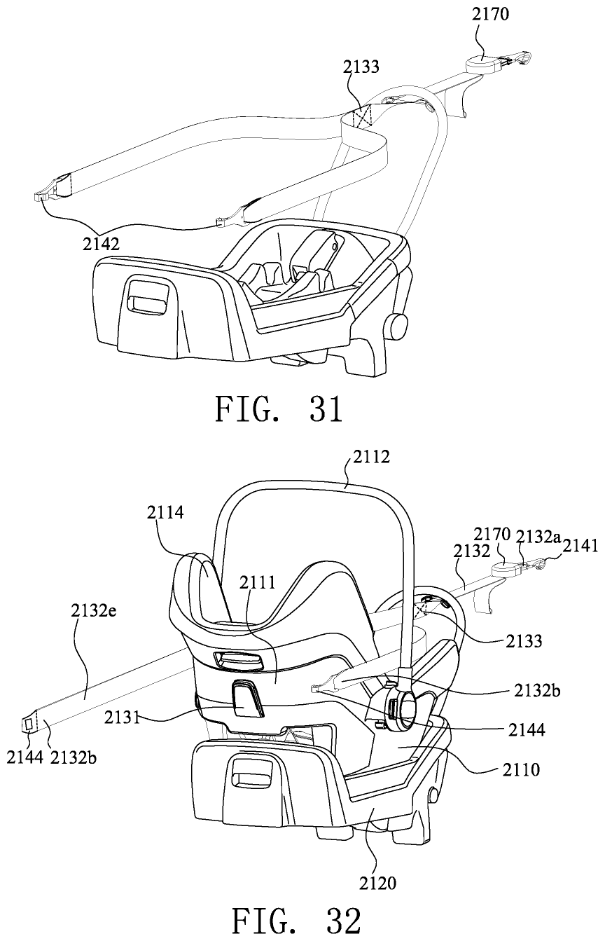

FIG. 29 shows the state of the seat body when the seat body 2110 of the child safety seat 2100 according to FIG. 27 leaves the base 2120, and FIG. 31 shows the state of the base 2120 after the seat body 2110 of the child safety seat 2100 according to FIG. 27 is removed. After disassembling the first part 2131 and the second part 2132 of the child safety seat 2100 according to the present invention, the seat body 2110 (infant basket) can be taken out separately (as shown in FIG. 29), when the top tether system is connected, the child safety seat 2100 can be connected to the vehicle. After the seat body 2110 of the child safety seat according to FIG. 27 is lifted, the first part 2131 is restricted from detaching from the seat body 2110 and remaining on the seat body 2110. The second part 2132 is restricted from detaching from the base 2120 and can remain on the base 2120 (as shown in FIG. 31) to avoid losing the top tether system and can reduce the weight of the seat body 2110 (infant basket). It should be noted that the third embodiment also includes the adjusting member 2170, and the second part 2132 can also include the adjusting section 2132d and the connecting section 2132c. The top rod structure also includes the top rod 2121 and the connection portion 2121c. These corresponding structures, as well as the specific way of the second part 2132 restricted to the top rod structure, are similar to the first embodiment mentioned above and will not be repeated here.

In the first to third embodiments mentioned above, the top tether system comprises a first connecting member 2141 and a second connecting member 2142 both connected to the second part 2132, and may further includes the adjusting member 2170 connected to the second part 2132. The first connecting member 2141 is configured to connect the vehicle, and the second connecting member 2142 is configured to connect the first part 2131 of the top tether system. Wherein, both the first connecting member 2141 and the second connecting member 2142 are restricted from passing through the penetration portion 2121b, or both the first connecting member 2141 and the adjusting member 2170 are restricted from passing through the penetration portion 2121b, or both the second connecting member 2142 and the adjusting member 2170 are restricted from passing through the penetration portion 2121b to prevent the second part 2132 from detaching from the base 2120. After the first part 2131 and the second part 2132 of the child safety seat 2100 according to the present invention are disassembled from each other, the seat body 2110 (infant basket) can be taken out separately and when the top tether system is connected, the child safety seat 2100 can be fixed to the vehicle. After the seat body 2110 of the child safety seat according to the present invention is lifted, the first part 2131 is restricted from detaching from the seat body 2110, and the second part 2132, which is a flexible strap structure, can also remain on the base 2120 (the second part 2132 passes through the penetration portion 2121b and is restricted from detaching from the penetration portion), thus avoiding the losing of the first part 2131 and the second part 2132, and reducing the weight of the seat body 2110 (infant basket). The second part 2132 is fixedly connected to the base 2120, which not only ensures that the second part 2132 will not be lost, but also that the base 2120 is installed on the vehicle seat at once and the second part 2132 is connected to the vehicle (regardless of whether the seat body 2110 is moved away or moved back and reinstalled on the base 2120). This part (the already installed base 2120 and the second part 2132 on the vehicle) does not need to be reinstalled, making it convenient to use.

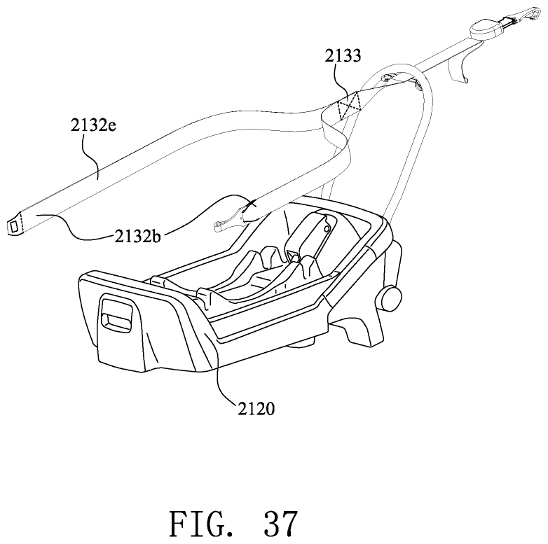

FIG. 32 is a perspective view of the fourth embodiment of the child safety seat 2100 according to the present invention. FIG. 34 shows the state of the seat body 2110 when the seat body 2110 of the child safety seat 2100 according to FIG. 32 leaves the base 2120. FIG. 37 shows the state of the base 2120 after the seat body 2110 of the child safety seat according to FIG. 32 is removed. In this embodiment, the first part 2131 is fixed to the seat body 2110, and the second part 2132 is a flexible strap structure (such as a woven strap). The first part 2131 can be a non-flexible structure (such as a metal structure), the first part 2131 can also be a flexible structure (such as a fabric), and the first part 2131 can have a certain elasticity, as long as its strength is sufficient to work together with the second part 2132 to firmly fix the child safety seat 2100 according to the present invention to the vehicle.

As shown in FIG. 32, the second part 2132 has one first end 2132a and two second ends 2132b, and the top tether system further includes one first connecting member 2141 and two fourth connecting members 2144. The first connecting member 2141 is provided at the first end 2132a and is configured to connect the vehicle, and the two fourth connecting members 2144 are respectively provided at the two second ends 2132b and are detachably connected to each other.

Specifically, in order to ensure a more stable connection between the two fourth connecting members 2144 in the tense state when using the second part 2132, in this embodiment, one of the two fourth connecting members 2144 has a hook, and the other of the two fourth connecting members 2144 has a connecting hole. The hook is snap fitted with the connecting hole to facilitate quick connection or disassembly of the two second ends 2132b of the second part 2132. In some embodiments, the two fourth connecting members 2144 may have structures such as Velcro or snap-fasteners. It should be noted that in some embodiments, either of the two fourth connecting members 2144 can be selectively set, for example, the two second ends 2132b of the second part 2132 are directly bound to each other are flexible strap structures, or one second end 2132b of the second part 2132 is a flexible strap structure, being tied or passed through and clamped to the fourth connecting member 2144 of the other second end 2132b (such as the fourth connecting member 2144 in the form of a sliplok buckle).

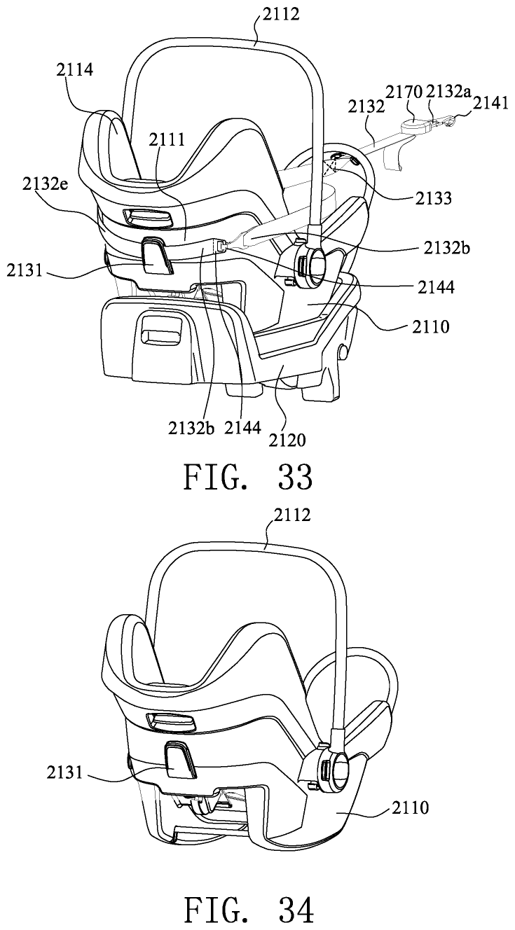

As shown in FIGS. 32 and 33, the second part 2132 has a surround portion 2132e, which is configured to surround the back 2111 of the seat body 2110. The first part 2131 is passed through by the surround portion 2132e. Specifically, in this embodiment, the second part 2132 has a Y-shaped structure, that is, two branches extend from the first end 2132a and form two second ends 2132b. In this embodiment, the surround portion 2132e of the second part 2132 surround the back 2111 is one of the branches. When the top tether system is installed and used, the second end 2132b of one of the branches of the second part 2132 connected with a hook or connecting hole bypasses one side wing 2114 of the seat body 2110 and surrounds the back 2111, so that the surround portion 2132e passes through the first part 2131 from the back 2111 of the seat body 2110, and then the second end 2132b is wound around the other side wing 2114 of the seat body 2110 and snap fit with the second end 2132b of the other branch. In this embodiment, if two side wings 2114 are considered to be connected on opposite sides in the left and right directions of the back 2111, the connection position of the two fourth connecting members 2144 are located on one side of the left and right directions of the first part 2131.

It should be noted that in other embodiments, the surround portion 2132e of the second part 2132 can be formed by two branches together. It can be understood that when the two second ends 2132b are connected to each other on the outer side of the back 2111, rather than on the outer side of the side wing 2114, the surround portion 2132e around the back 2111 is formed by two branches together. For example, in one embodiment, the surround portions 2132e of two branches respectively pass through the first part 2131 (both surround portions 2132e pass through the first part 2131 at the same time), and the two fourth connecting members 2144 can be detachably connected on the back side of the first part 2131. In this embodiment, the first part 2131 can be fixed in the middle position of the back 2111 of the seat body 2110, so that the first part 2131 and the second part 2132 can be connected to each other under evenly force. For another example, the first part 2131 is not fixed in the middle position of the back 2111, but leans towards one side of the back 2111. That is, if two side wings 2114 are considered to be connected on the left and right sides of the back 2111, the first part 2131 leans towards the left side wing 2114 or the right side wing 2114 of the back 2111. At this time, the two branches can jointly form the surround portion 2132e to surround the back 2111. The two second ends 2132b of the two branches (or two fourth connection portions 2144) are connected on one side of the first part 2131, that is, the connection position of the two second ends 2132b (or two fourth connection portions 2144) are located between the first part 2131 and the right side wing 2114, or between the first part 2131 and the left side wing 2114.

It can be understood that the two fourth connecting members 2144 of this embodiment are used for detachable connection on the external side of the first part 2131 to facilitate user operation, wherein “the external side of the first part 2131” can be one side in the left and right directions or the back side of the first part 2131.

As shown in FIG. 36, the first part 2131 has an installation portion 2151a for installing on the back 2111 of the seat body 2110 and a second fixing portion 2152a connected to the installation portion 2151a. There is a gap 2153a between the installation portion 2151a and the second fixing portion 2152a, and the surround portion 2132e of the second part 2132 passes through the gap 2153a. One end 2152c of the second fixing portion 2152a of the first part 2131 is connected to the installation portion 2151a of the first part 2131, and the other end 2152e of the second fixing portion 2152a is suspended to form an opening for the first part 2131. The second fixing portion 2152a of the first part 2131 is provided with a blocking portion 2154a at the position corresponding to the opening. The a blocking portion 2154a restricts the surround portion 2132e of the second part 2132 from detaching from the gap 2153a, avoiding accidental separation after the connection between the second part 2132 and the first part 2131. That is to say, when the surround portion 2132e passes through the first part 2131 from the back 2111 of the seat body 2110, the surround portion 2132e passes over the blocking portion 2154a from the other end 2152e of the second fixing portion 2152a of the first part 2131, and enters the gap 2153a between the blocking portion 2154a and the installation portion 2151a. The shape of the blocking portion 2154a (such as the barbed shape shown in FIG. 36) is constructed so that the surround portion 2132e can easily cross the blocking portion 2154a and enter the gap 2153a, and then be restricted by the blocking portion 2154a to prevent detachment from the second fixing portion 2152a. The second fixing portion 2152a or blocking portion 2154a is elastic, so that when the seat body 2110 is removed from the base 2120, the surround portion 2132e can be detached from the gap 2153a by utilizing the elastic deformation of the second fixing portion 2152a or blocking portion 2154a. Of course, the fixing method between the first part 2131 and the seat body 2110 is not limited to this. If the first part 2131 is a flexible structure (such as fabric), it can also be directly fixed to the corresponding fabric on the back 2111 of the seat body 2110 through sewing or other methods. That is to say, the first part 2131 is fixed to the seat body 2110 in different implementations. For example, the first part 2131 is installed and fixed to the seat body 2110, such as the first part 2131 is installed to the seat body 2110 through fasteners such as rivets or screws, or through a clamping structure between the first part 2131 and the seat body 2110; alternatively, the first part 2131 can be fixed to the seat body 2110 through integrated formation. It should be noted that the first part 2131 is fixed to the outer side of the back 2111 of the backrest portion 2113 of the seat body 2110 through separate installation or integrated formation, so that the top tether system can be applied without damaging the rigidity of the seat body 2110 (for child protection performance).

Preferably, the first part 2131 installed on the seat body 2110 is located at the approximate center of the back 2111 of the backrest portion 2113 of the seat body 2110, so that when using the child safety seat according to the present invention in a vehicle, the top tether system can evenly apply force to fix the seat body 2110 to the vehicle. The second part 2132 has two second ends 2132b and one first end 2132a, forming a Y-shaped flexible strap structure as a whole. The branch where one second end 2132b is located is longer than the branch where the other second end 2132b is located due to the surround portion 2132e (as shown in FIGS. 32 and 37). That is to say, the length of one fourth connecting member 2144 to the first end 2132a is greater than the length of another fourth connecting member 2144 to the first end 2132a. The intersection of the three branches of the second part 2132 forms the middle intersection point of the Y-shaped structure (with the same stitching position 2133 as the previous embodiment). When the top tether system is connected to the vehicle for use, the middle intersection point is also located in the approximate longitudinal symmetry plane of the seat body 2110, so that when using the child safety seat according to the present invention in the vehicle, the top tether system can evenly apply force to fix the seat body 2110 to the vehicle.

In this embodiment, by setting the two second ends 2132b of the second part 2132 to be detachably connected to each other, specifically, the two fourth connecting members 2144 (the hook and connecting hole) can be detachably connected on the side surface (side wing surface) of the seat body 2110, when the caregiver does not need to lift the seat body 2110 and only wants to pick up the baby, they only need to disassembly the connection between the hook and connecting hole, and the caregiver can pick up the baby from the side of the seat body 2110, maintaining the connection between the second part 2132 and the first part 2131. When the baby is placed again in the seat body 2110, the caregiver does not need to connect the second part 2132 to the first part 2131, but only needs to connect the hook of the second part 2132 to the connecting hole, and the woven strap (second part 2132) blocks the path for children to enter and exit the seat body 2110, making it convenient to use. It should be noted that the fourth embodiment also includes the adjusting member 2170, and the second part 2132 can also include the adjusting section 2132d and the connecting section 2132c. The top rod structure also includes the top rod 2121 and the connection portion 2121c. These corresponding structures, as well as the specific ways of the second part 2132 limited to the top rod structure, are similar to the first embodiment mentioned above and will not be repeated here.

In addition, similar to the first to third embodiments, in this embodiment, after the first part 2131 and the second part 2132 of the child safety seat 2100 according to the present invention are disassembled from each other, the seat body 2110 (infant basket) can be taken out separately and when the top tether system is connected, the child safety seat 2100 can be fixed to the vehicle. After the seat body 2110 of the child safety seat according to the present invention is lifted, the first part 2131 is restricted from detaching from the seat body 2110, and the second part 2132, which is a flexible strap structure, can also remain on the base 2120 (the second part 2132 passes through the penetration portion 2121b and is restricted from detaching from the penetration portion), thus avoiding the losing of the first part 2131 and the second part 2132, and reducing the weight of the seat body 2110 (infant basket). The second part 2132 is fixedly connected to the base 2120, which not only ensures that the second part 2132 will not be lost, but also that the base 2120 is installed on the vehicle seat at once and the second part 2132 is connected to the vehicle (regardless of whether the seat body 2110 is moved away or moved back and reinstalled on the base 2120). This part (the already installed base 2120 and the second part 2132 on the vehicle) does not need to be reinstalled, making it convenient to use.

It should be noted that in the above embodiments, in order to connect the second part 2132 to the top rod structure, the second part 2132 can first pass through the penetration portion 2121b before connecting the first connecting member 2141, the second connecting member 2142 (in the fourth embodiment, the fourth connecting member 2144 replaces the second connecting member 2142), and then the first connecting member 2141, the second connecting member 2142 (in the fourth embodiment, the fourth connecting member 2144 replaces the second connecting member 2142), and the adjusting member 2170 can be connected to the second part 2132, and then the second part 2132 can be restricted from detaching from the base 2120. Alternatively, the first connecting member 2141, the second connecting member 2142 (in the fourth embodiment, the fourth connecting member 2144 replaces the second connecting member 2142) and the adjusting member 2170 can be connected to the second part 2132. Before connecting the connection portion 2121c to the top rod 2121, the second part 2132 can be passed through the top rod 2121, and then when connecting the connection portion 2121c to the abut portion 2121a, the second part 2132 can be set in the penetration portion 2121b located between the abut portion 2121a and the connection portion 2121c.

It should be noted that in the above embodiments, any two of the adjusting member 2170, the first connecting member 2141, and the second connecting member 2142 (in the fourth embodiment, the fourth connecting member 2144 replaces the second connecting member 2142) are restricted from passing through the penetration portion 2121b to achieve the second part 2132 being restricted from detaching from the base 2120, without the need for additional components, resulting in lower costs and fewer installation steps. But in addition to this method, there can also be other ways to achieve the second part 2132 being restricted from detaching from the base 2120. For example, the second part 2132 has a woven strap structure, and a part of it is sewn together to form a circular structure that surrounds the top rod structure; alternatively, the second part 2132 has a woven strap structure, and a part of it is stacked into multiple layers and sewn together to form a thicker knot that is restricted from passing through the penetration portion 2121b; alternatively, two additional components (such as plastic blocks) can be specifically provided to connect to the second part 2132, which are located on both sides of the top rod structure to be restricted from passing through the penetration portion 2121b.

It should be noted that in the third embodiment, there are two second connecting members 2142 located on the same side of the penetration portion 2121b, and in the fourth embodiment, there are two fourth connecting members 2144 located on the same side of the penetration portion 2121b. When the second connecting member 2142 or the fourth connecting member 2144 is needed to help restrict the detachment of the second part 2132 from the base 2120, the present application does not limit all second connecting members 2142 or all fourth connecting members 2144 to be restricted from passing through the penetration portion 2121b, as long as any second connecting member 2142 or the fourth connecting member 2144 is restricted from passing through the penetration portion 2121b.

For example, in the fourth embodiment, there are two fourth connecting members 2144 located on the same side of the penetration portion 2121b and detachably connected to each other. One of the fourth connecting members 2144 in the fourth embodiment is flat and has a connecting hole, and the other fourth connecting member 2144 has a hook. In the fourth embodiment, one of the fourth connecting members 2144 (i.e. the fourth connecting member 2144 with a hook) is restricted from passing through the penetration portion 2121b. Even if there is a flat fourth connecting member 2144 that can pass through the penetration portion 2121b, since the two fourth connecting members 2144 are located on the same side of the penetration portion 2121b, it is still possible to restrict the second part 2132 from detaching from the base 2120.

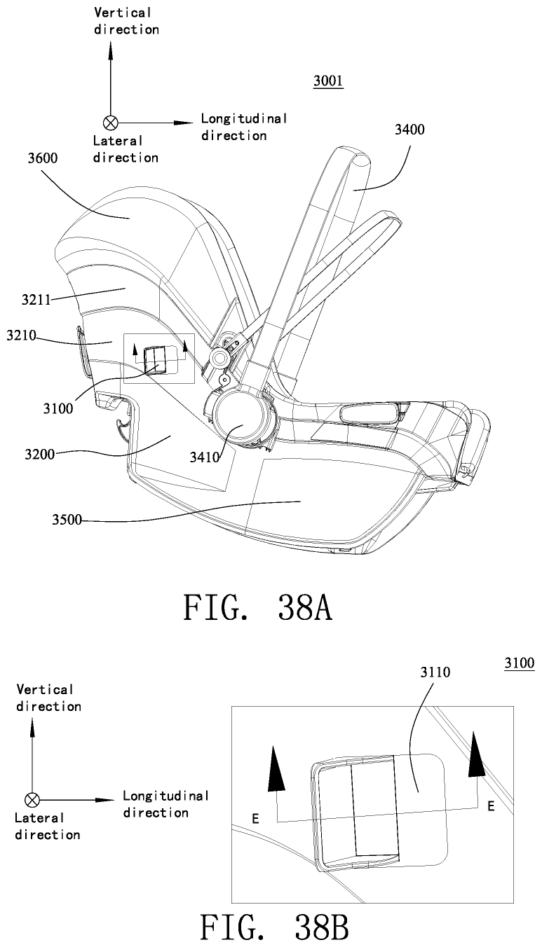

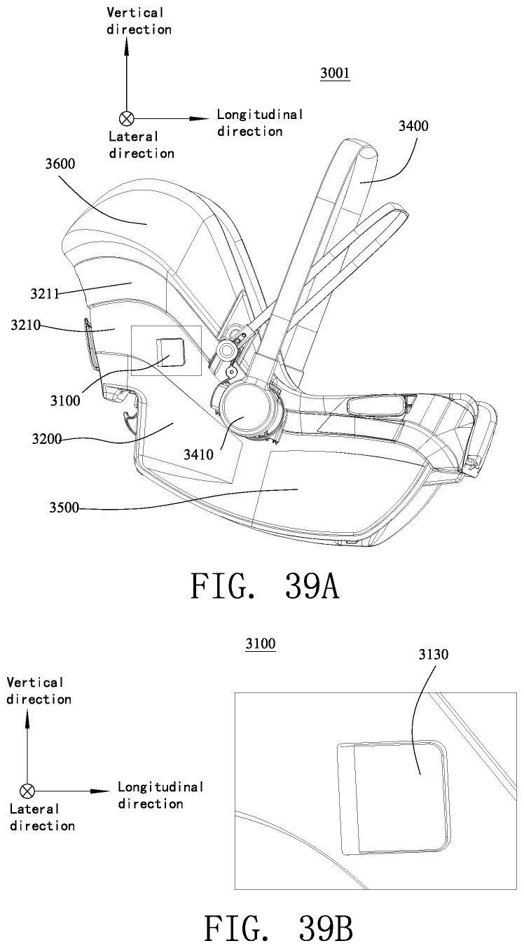

Referring to FIGS. 38A to 39B, the overall description of the child safety seat 3001 and the connecting structure 3100 according to the present application is provided. In the embodiment of the present application, the connecting structure 3100 is applied to the child safety seat 3001. However, it should be understood that in other embodiments, the connecting structure 3100 can also be applied to other forms of carriers such as sleeping baskets, pet carriers, etc.

The child safety seat 3001 includes the seat body 3200 and two connecting structures 3100. The seat body 3200 is a part for children to ride in, which includes a leaning portion 3220, a seating portion 3230, and two side wings 3210. In the present application, for ease of description, the front and rear directions of the seat body 3200 are referred to as longitudinal direction, the up and down directions are referred to as vertical direction, and the left and right directions are referred to as lateral direction. However, it should be understood that these directions do not limit the setting method of the child safety seat 3001 and the connecting structure 3100, and the longitudinal, transverse, and vertical directions do not need to be perpendicular to each other.

The child safety seat 3001 may further include one or more cushion blocks 3600 provided on the seat body 3200, the cushion block 3600 is placed in the seating space of the child safety seat 3001. FIG. 38A illustrates a cushion block 3600 extending vertically and its top being higher than the seat body 3200. The cushion block 3600 can be supported above the side wing 3210 and the leaning portion 3220. The cushion block 3600 is made of foam material (such as EPP material) and can also be set in other known forms in the art. The child safety seat 3001 can also include a seat cloth (not shown) covering the cushion block 3600.

The connecting structure 3100 has a cover body 3130 that can be opened to expose the interior of the connecting structure 3100 (see FIGS. 38A and 38B) or closed to mask the interior of the connecting structure 3100 (see FIGS. 39A and 39B). The following text will provide a detailed description of the connecting structure 3100 and the cover body 3130 thereof.

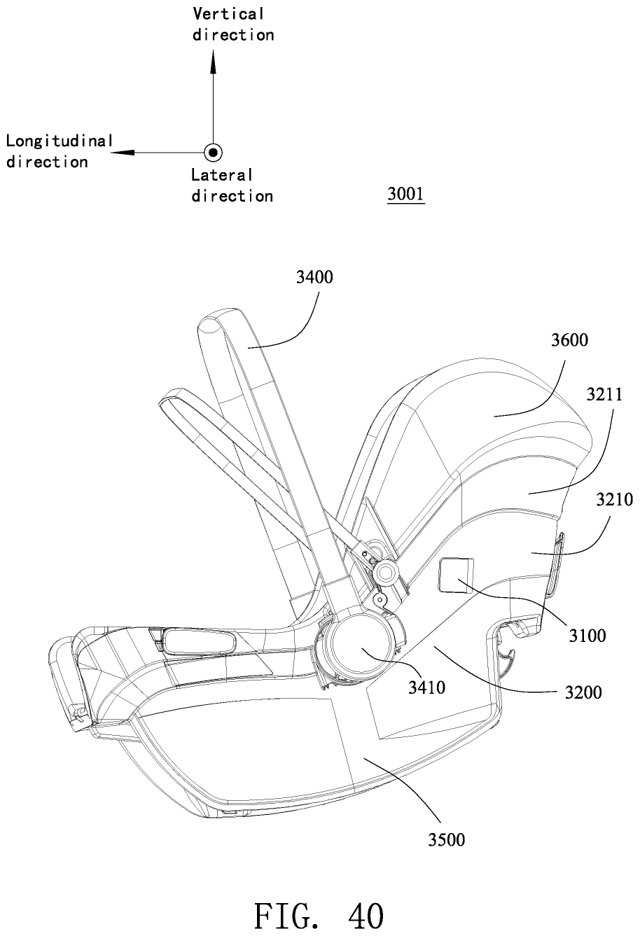

FIG. 40 shows a side view of the child safety seat 3001 from another side, where it can be seen that there is also a connecting structure 3100 on the other side. That is to say, the two connecting structures 3100 can be symmetrically arranged on both sides of the child safety seat 3001. However, two connecting structures 3100 can also be asymmetrically set, or only one connecting structure 3100 can be set.

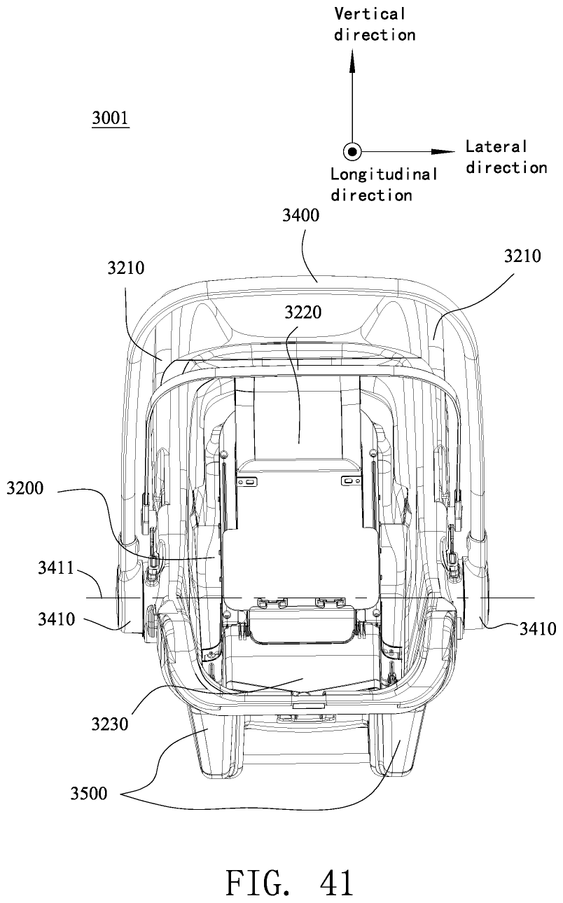

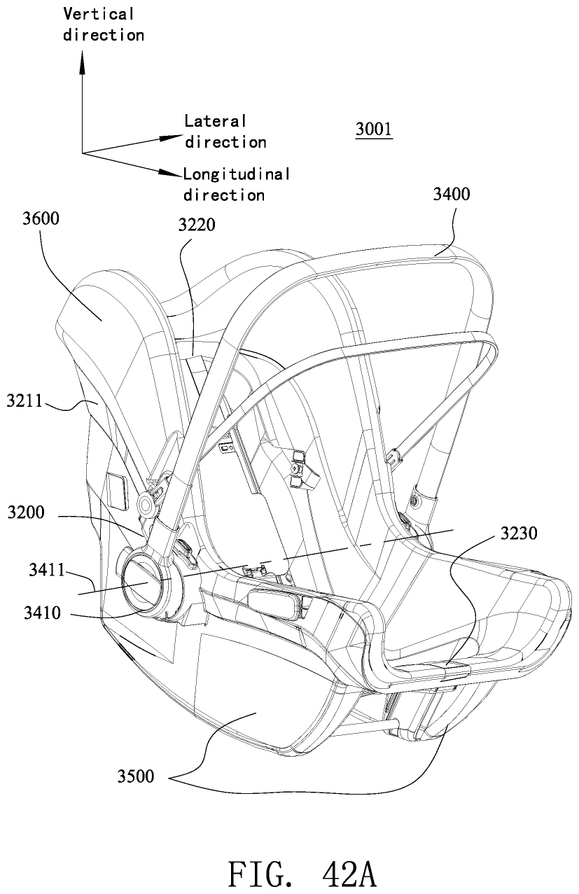

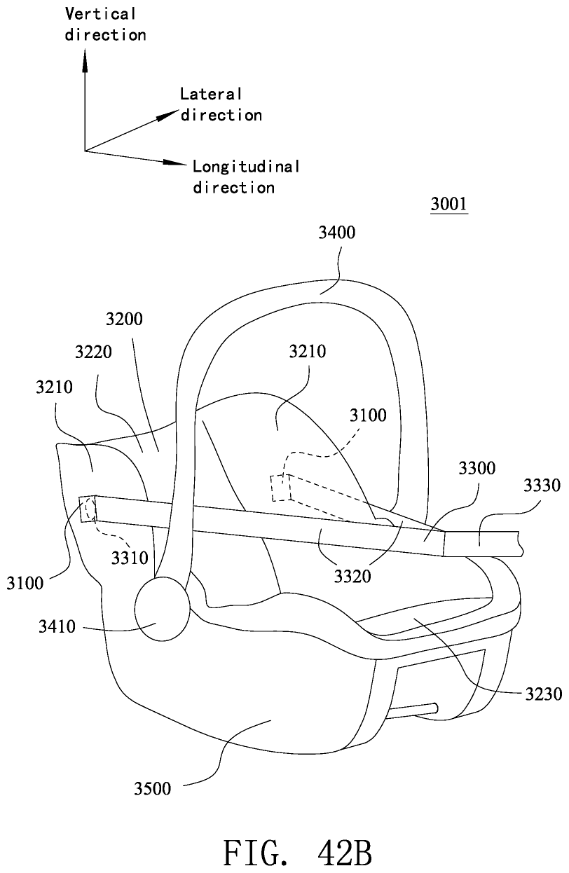

Referring to FIGS. 41 to 42B, the overall structure of the child safety seat 3001 will be further described.

The child safety seat 3001 in this embodiment is an infant basket, and the child safety seat 3001 further includes a carrying handle 3400 pivotally connected to both sides of the seat body 3200. The carrying handle 3400 can rotate relative to the seat body 3200, for example, around a transverse axis. Therefore, the user can lift the seat body 3200 by the carrying handle 3400. The child safety seat 3001 is used for detachable connection with a base (not shown), the base can be installed in a vehicle (not shown). Therefore, the child safety seat 3001 can be connected to the base and used in the vehicle or separated from the base as a separate infant basket. The child safety seat 3001 further includes two connection portions 3500 connected to the seating portion 3230, each of which can be located below the seating portion 3230. Two connection portions 3500 are spaced apart from each other and constructed to be connected in conjunction with the base. For example, the connection portion 3500 can be connected to the base through another clamping mechanism (not shown), and the present application does not limit the form of the clamping mechanism. Of course, in other embodiments, the child safety seat 3001 may be in other forms, not limited to the form of the infant basket.

The leaning portion 3220 is located behind the seating portion 3230 and extends upwards, the two side wings 3210 are located on both sides of the leaning portion 3220. The side wing 3210 is configured to provide a more comfortable and safe riding environment for children, and some devices of the child safety seat 3001 can be installed on the side wing 3210. Both connection portions 3500 extend downwards to facilitate installation to the base (not shown).

Two connecting structures 3100 are respectively set on two wings 3210. More specifically, in this embodiment, the connecting structure 3100 can be set near the middle position in the vertical direction of the seat body 3200, but is not limited to this, and the position of the connecting structure 3100 can be flexibly adjusted according to the installation requirements of the tether 3300.

Referring to FIGS. 42A to 42B, FIG. 42B schematically illustrates that the tether 3300 is connected to the child safety seat 3001.

More specifically, the carrying handle 3400 has two pivot portions 3410 connected to both sides of the seat body 3200 respectively, each pivot portion 3410 having a pivot center 3411. The carrying handle 3400 can rotate around the pivot center 3411 relative to the seat body 3200. The connecting structure 3100 is located on the side wing 3210 and is near the rear and upper parts of the seat body 3200 relative to the pivot center 3411. For example, in this embodiment, each side wing 3210 has an extending portion 3211 extending outward and downward from its upper edge (see FIG. 38, FIG. 42A), and the connecting structure 3100 is located below the extending portion 3211. In addition, the connecting structure 3100 can be located above the seat body 3200 relative to the connection portion 3500. The seat cloth (not shown) of the child safety seat covers the cushion block 3600 and can be extended outward to wrap the side of the cushion block 3600. The seat cloth can also be clamped at the extending portion 3211 to be connected to the seat body 3200. In addition, the connecting structure 3100 is located in front of the front surface of the leaning portion 3220 of the seat body 3200 in the front and rear direction.

It should be understood that the bottom of typical child safety seats can be fixed to carriers such as vehicles through a base, so that in the event of a collision, the upper part of the seat body may tilt, for example, towards the rear of the child safety seat (i.e. the front of the vehicle's direction of travel), posing a safety hazard. The overall structure of the child safety seat 3001 according to the present application, the connecting structure 3100 is located near the rear and upper parts of the seat body 3200. Therefore, the tether 3300 connected to the child safety seat 3001 through the connecting structure 3100 can apply a large tensile torque to the seat body 3200, effectively preventing the seat body 3200 from tilting backwards. On the other hand, due to the distance between the connecting structure 3100 and the upper edge of the seat body 3200, the structural strength of the seat body 3200 will not be significantly affected. Furthermore, when the child safety seat 3001 is installed in the vehicle, the side wings 3210 of the child safety seat 3001 face the door. Due to the connecting structure 3100 located at the side wing 3210, the connecting structure 3100 is operable at the car door to connect or detach the tether 3300 from the seat body 3200, thereby increasing operational convenience.

In the present application, the tether 3300 is connected to the upper part of the side wing 3210 of the seat body 3200. However, the present application is not limited to this, and the tether 3300 can be connected to other appropriate positions of the seat body 3200, such as the bottom or back.

More specifically, the tether 3300 includes an extension portion 3330 and two branch portions 3320. One end of each branch portion 3320 is connected to two connecting structures 3100 set on the seat body 3200 respectively, and the other end of each branch portion 3320 is merged with each other, for example, sewn together. The extension portion 3330 extends from the merged ends of the branch portions 3320, and the extension portion 3330 can be directly connected to a vehicle (not shown). For example, the extension portion 3330 can be sewn to the merging position of two branch portions 3320, and one end of the extension portion 3330 that is not connected to the branch portion 3320 can be provided with a connecting member (not shown) to connect to the seat of the vehicle (not shown); the end of the extension portion 3330 that are not connected to the two branch portions 3320 can also be firstly connected to other tethers (not shown), and then connected to a vehicle (not shown) through the other tethers.

Each branch portion 3320 is connected to the corresponding connecting structure 3100 through the second connecting member 3310 respectively, and the cover body 3130 of the connecting structure 3100 can cover the second connecting member 3310, which will be described in detail below. Therefore, the interior of the connecting structure 3100 and the second connecting member 3310 are obstructed by the cover body 3130, providing a clean visual effect, while also avoiding unnecessary scratches caused by the exposed parts of the connecting structure 3100 and the second connecting member 3310, or preventing debris from entering the interior of the connecting structure 3100 and affecting the normal use of the connecting structure 3100.

In the present application, the child safety seat 3001 is fixed to the vehicle in a back-facing manner, that is, the back of the seat body 3200 is facing the forward direction of the vehicle. Therefore, when the tether 3300 is connected to the seat of the vehicle, the child safety seat 3001 is stably fixed in the vehicle.

Moreover, in this embodiment, the tether 3300 extends along the longitudinal direction of the child safety seat 3001, and the second connecting member 3310 is connected to the connecting structure 3100, for example, inserted along the lateral direction of the child safety seat 3001 and connected to the connecting structure 3100 (as detailed below). In the event of a vehicle collision, the tether 3300 experiences significant longitudinal tension. At this point, due to the transverse insertion of the second connecting member 3310 into the connecting structure 3100, the risk of the second connecting member 3310 detaching from the connecting structure 3100 under longitudinal tension is reduced, and the stability of the connection between the connecting structure 3100 and the second connecting structure 3310 is increased, thereby improving the safety performance of the child safety seat 3001. It should be noted that the tether 3300 extends along the longitudinal direction of the child safety seat 3001 does not limit the tether 3300 to extend completely straight along the longitudinal direction, but rather refers to the overall shape of the tether 3300 extending roughly along the longitudinal direction, with the tension direction of the tether 3300 roughly in the longitudinal direction. For example, it can be understood that the tether 3300 is made of flexible materials. When the tether 3300 extends from the connecting structure 3100 to the outside, the part close to the connecting structure 3100 that extends outward may undergo some deformation due to the need to bypass other structures of the seat body 3200.

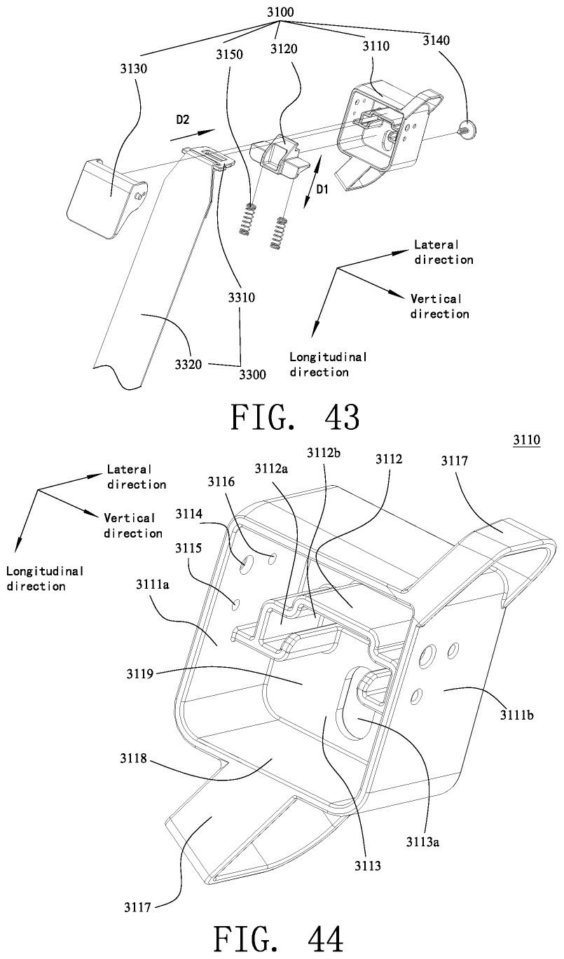

Referring to FIG. 43, further describe the connecting structure 3100 and the tether 3300 according to the present application.

The connecting structure 3100 includes an accommodating portion 3110, a first connecting member 3120, a cover body 3130, a guiding member 3140, and a resetting member 3150. The tether 3300 includes the branch portion 3320 as described earlier and the second connecting member 3310 connected to the branch portion 3320.

The accommodating portion 3110 is installed on the child safety seat 3001, for example, embedded in the side wing 3210 of the seat body 3200 (see FIG. 38B). In this embodiment, the accommodating portion 3110 is a separate component and is assembled into a component with the first connecting member 3120, the cover body 3130, and other components before being installed on the child safety seat 3001. In other embodiments, the accommodating portion 3110 can also be integrally formed with the seat body 3200, for example, forming a part of the side wing 3210 of the seat body 3200.

The first connecting member 3120 is arranged in the accommodating portion 3110 and can slide along a sliding direction D1 to switch between the locking position and the unlocking position. The cover body 3130 is installed on the accommodating portion 3110 and can be converted between the open position and the closed position relative to the accommodating portion 3110. In this embodiment, the cover body 3130 is pivotally connected to the accommodating portion 3110, thus pivoting between the open position and the closed position. In other embodiments, the cover body 3130 may be a sliding or detachable component relative to the accommodating portion 3110. The resetting member 3150 is configured to bias the first connecting member 3120 towards the locking position. The guiding member 3140 is configured to slide the first connecting member 3120 to the accommodating portion 3110 and guide the sliding direction D1 of the first connecting member 3120. The specific operations of the above components will be described in detail in the following text.

Referring to FIG. 44, describe the specific structure of the accommodating portion 3110.

The accommodating portion 3110 includes an inner side surface 3113, four side walls, an extension wall 3112, an accommodating chamber 3118, and an installation portion 3117, wherein the accommodating chamber 3118 has an opening 3119. For ease of description, the two side walls extending along the longitudinal direction among the four side walls are referred to as the first side wall 3111a and the second side wall 3111b, respectively. In some embodiments, the accommodating portion 3110 may be an independent component installed on the child safety seat 3001, such as a separate housing, installed to the carrier through bolts or welding. In other embodiments, the accommodating portion 3110 may be a portion integrally formed with the vehicle, such as a recess formed on the side of the child safety seat 3001. In this embodiment, as shown in FIG. 44, the accommodating portion 3110 is an independent component installed on the child safety seat 3001, the installation portion 3117 is fixed to the carrier by fasteners such as bolts (not shown), thereby achieving the installation of the accommodating portion 3110 onto the carrier.

The inner side surface 3113 is opposite to the opening 3119. When the accommodating portion 3110 is installed on the seat body 3200 of the child safety seat 3001 or forms a part of the seat body 3200, the inner side surface 3113 is located inside the child safety seat 3001, and the opening 3119 is facing the outer side of the child safety seat 3001. In this embodiment, the four side walls of the accommodating portion 3110 are all connected to the inner side surface 3113, with the first side wall 3111a and the second side wall 3111b extending along the longitudinal direction facing each other, for example, in the vertical direction, and the other two side walls facing each other. Therefore, the accommodating portion 3110 is formed into a box shaped structure with a roughly rectangular shape and one side open.

It should be noted that in this embodiment, the accommodating portion 3110 can be an independent component installed on the child safety seat 3001, which itself forms four side walls; but in other embodiments, the number of side walls can be adjusted, and in other embodiments, the independent component can have one, two, or three side walls of its own. Therefore, when the accommodating portion 3110 is installed on the seat body 3220, it forms an accommodating portion 3110 with more side walls together with the parts on the seat body 3200, or the accommodating portion 3110 and its side walls are a structure formed by the integrated formation of the seat body 3200.

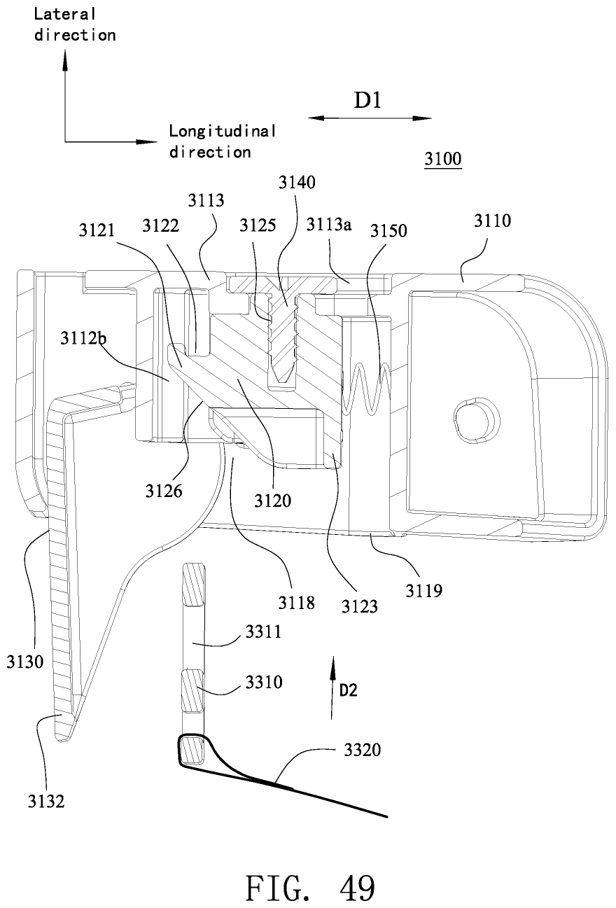

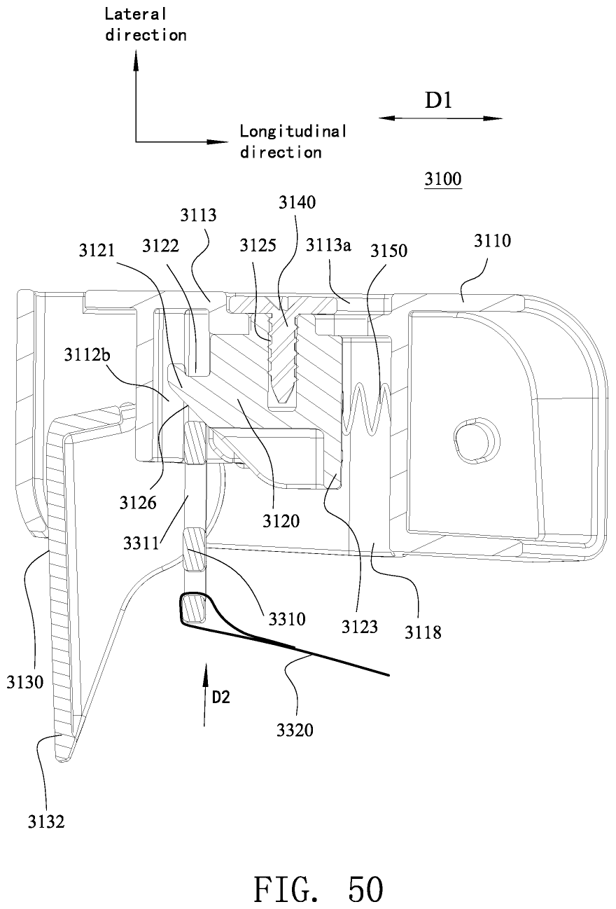

The extension wall 3112 extends from the inner side surface 3113 towards the opening 3119 to form a clamping space 3112a and a yielding space 3112b. The clamping space 3112a defines the insertion direction D2 of the second connecting member 3310, and the yielding space 3112b provides space for the first connecting member 3120 to move to the locking position. When the first connecting member 3120 is in the locking position, the first connecting member 3120 is at least partially located within the yielding space 3112b. More specifically, the extension wall 3112 can be integrally formed with the inner side surface 3113, for example, by injection molding. The extension wall 3112 surrounds to form the clamping space 3112a and the yielding space 3112b. The clamping space 3112a close to the unlocking position of the first connecting member 3120, and the yielding space 3112b close to the locking position of the first connecting member 3120. The clamping space 3112a can be opened on the side facing the unlocking position to allow the first connecting member 3120 to enter the clamping space 3112 (see FIG. 49). It should be noted that in other embodiments, the extension wall 3112 defining the insertion direction of the second connecting member 3310 may be omitted. For example, by matching the shape of the second connecting member 3310 with the side wall of the accommodating portion 3110, the insertion direction of the second connecting member 3310 can also be defined.

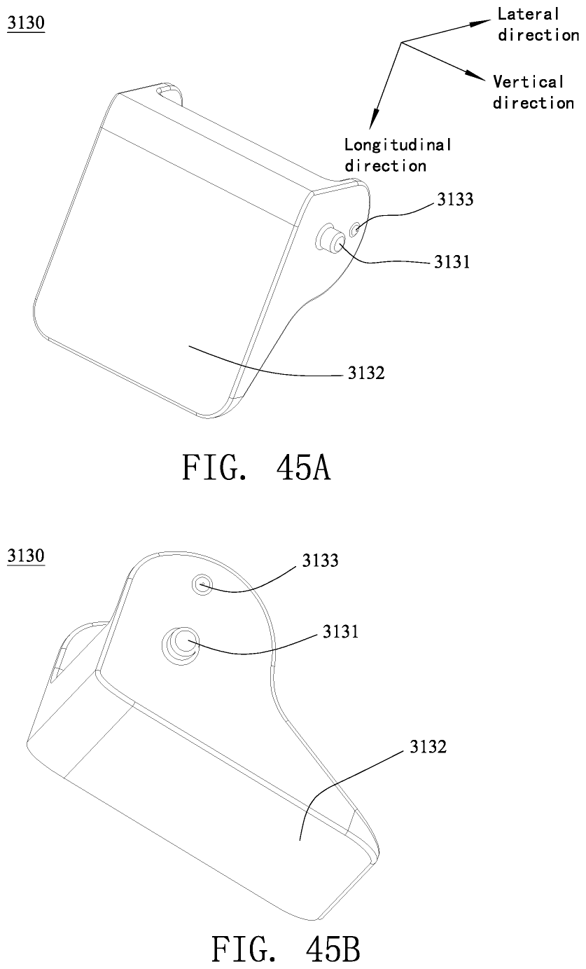

The first side wall 3111a and the second side wall 3111b are respectively provided with shaft holes 3114, and there is open positioning recess 3115 and closed positioning recess 3116 around the shaft holes 3114. Referring to FIGS. 45A and 45B, the specific structure of the cover body 3130 is shown. The cover body 3130 includes a pivot shaft 3131 and a free end 3132 opposite to the pivot shaft 3131, and there is positioning protrusion 3133 around the pivot shaft 3131 of the cover body 3130. The pivot shaft 3131 of the cover body 3130 is inserted into the shaft hole 3114 to allow the cover body 3130 to pivot relative to the accommodating portion 3110, and when the cover body 3130 is in the closed position, the free end 3132 closes the opening 3119 of the accommodating portion 3110. Moreover, when the cover body 3130 is in the open position and the closed position respectively, the positioning protrusion 3133 is engaged in the open positioning recess 3115 and the closed positioning recess 3116 to keep the cover body 3130 in the open position and the closed position.

In other embodiments, the first side wall 3111a and the second side wall 3111b are not provided with an open positioning recess 3115 and a closed positioning recess 3116, but are respectively provided with an open positioning protrusion and a closed positioning protrusion around the shaft hole 3114, and a positioning recess is provided around the pivot shaft 3131 of the cover body 3130. In this way, when the cover body 3130 is in the open and closed positions, the positioning recess is engaged to the open positioning protrusion and the closed positioning protrusion, respectively.

Further referring to FIG. 44, the accommodating chamber 3118 is located between the inner side surface 3113 and the opening 3119, for accommodating the first connecting member 3120. The accommodating portion 3110 further includes a guide groove 3113a provided in the inner side surface 3113, and the guide groove 3113a corresponds to the position of the accommodating chamber 3118. The guiding member 3140 defines the sliding direction D1 of the first connecting member 3120 through the guide groove 3113a (detailed below). However, it should be understood that in other embodiments, guide structures such as guide rails and limit blocks may also be provided in the accommodating chamber 3118 to limit the sliding direction D1 of the first connecting member 3120.

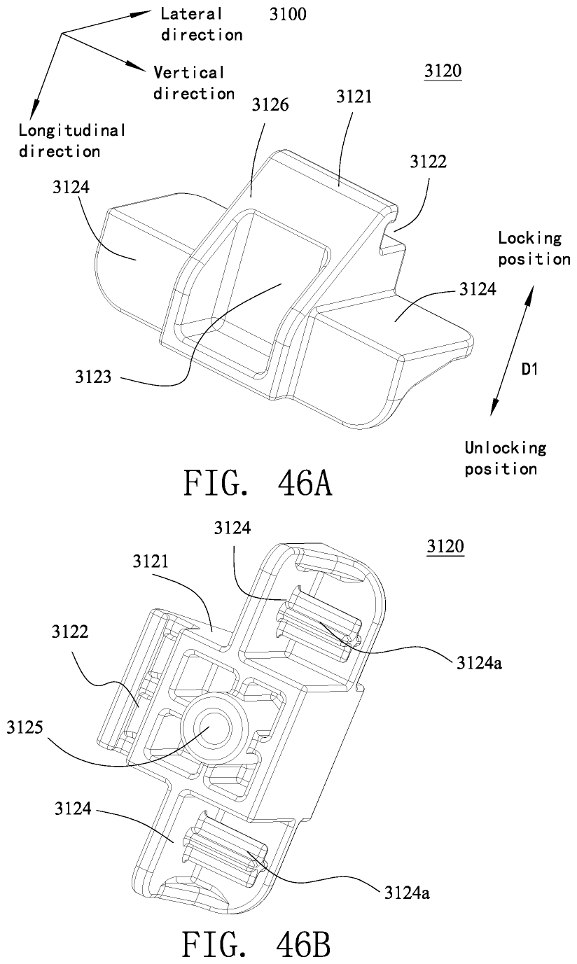

Referring to FIGS. 46A and 46B, describe the specific structure of the first connecting member 3120.

The first connecting member 3120 includes a hook portion 3121, a clamping portion 3122, a pressing portion 3123, an abut portion 3124, a connecting hole 3125, and an inclined plane 3126. As mentioned earlier, the first connecting member 3120 slides between the locking and unlocking positions along the sliding direction D1. For ease of understanding, the structure of the first connecting member 3120 is described based on the directions of the locking and unlocking positions herein.

The hook portion 3121 is close to the locking position and is constructed to be connected to the first connecting member 3120. More specifically, the inner side (i.e. the right side of FIG. 46A) and the outer side (i.e. the left side of FIG. 46A) of the hook portion 3121 are respectively provided with the clamping portion 3122 and the inclined plane 3126. The clamping portion 3122 is set as a groove that is recessed towards the outside into the hook portion 3121, more specifically an elongated groove that extends along the vertical direction. The inclined plane 3126 is inclined towards the inner side of the hook portion 3121, so that the hook portion 3121 forms the tip of a triangle. As will be described in the following text in conjunction with the operation of the connecting structure 3100, the function of the clamping portion 3122 is to hold the second connecting member 3310, and the function of the inclined plane 3126 is to assist the second connecting member 3310 in inserting into the connecting structure 3100. In this embodiment, the shape of the clamping portion 3122 and the inclined plane 3126 is advantageous in providing a compact structure. However, in other embodiments, the clamping portion 3122 and the inclined plane 3126 can also be set in different forms, as long as the second connecting member 3310 can be held and the second connecting member 3310 can be assisted in inserting into the connecting structure 3100.

The pressing portion 3123 is provided on one side of the first connecting member 3120 adjacent to the opening 3119, and the pressing portion 3123 is close to the unlocking position. The pressing portion 3123 is configured to be pressed to move the first connecting member 3120 to the unlocking position. More specifically, the pressing portion 3123 is set as a recess portion and has a wall extending along the lateral direction near the unlocking position for the user to operate the pressing portion 3123. In this embodiment, the deformation direction of the resetting member 3150 is along the longitudinal direction. After the user's fingers enter the recess portion, they can press the wall along the longitudinal direction to move the first connecting member 3120 to the unlocking position. It should be understood that the pressing portion 3123 can also be set in other appropriate forms, such as a corrugated friction surface.

The connecting hole 3125 is provided on the inner side surface 3113 (left side of FIG. 46B) of the first connecting member 3120. Insert the guiding member 3140 into the connecting hole 3125 to limit the sliding direction D1 of the first connecting member 3120 (see FIG. 49). In this embodiment, the guiding member 3140 is a screw, with its tail connected to the connecting hole 3125, and its head stopped on one side of the guide groove 3113a to prevent the first connecting member 3120 from detaching from the accommodating chamber 3118.

Two abut portions 3124 are respectively set on both sides of the pressing portion 3123 to limit the sliding range of the first connecting member 3120 and provide an abut surface for the resetting member 3150, which will be described in detail below.

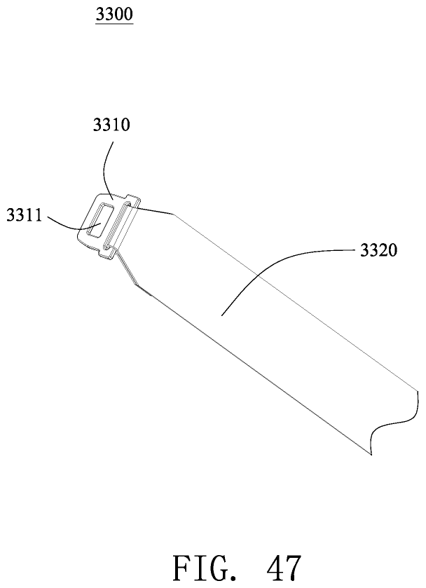

Referring to FIG. 47, the specific structure of the branch portion 3320 of the tether 3300 and the second connecting member 3310 is described.

The branch portion 3320, for example, is a flexible woven strap, with one end connected to the second connecting member 3310. The form of the second connecting member 3310 is specifically a buckle, which is, for example, a sheet metal material, and the second connecting member 3310 is provided with a clamping hole 3311. The shape of the clamping hole 3311 is set to allow the hook portion 3121 of the first connecting member 3120 to pass through. In this embodiment, the clamping hole 3311 is set as an elongated hole. However, in other embodiments, the clamping hole 3311 can also be set in other shapes such as square, trapezoidal, elliptical, etc. to match different forms of the hook portion 3121.

In this embodiment, the form of the second connecting member 3310 is a buckle, however, in other embodiments, the form of the second connecting member 3310 can also be a hook, mushroom head, hanging ring, etc. The connection structure 3100 of the present application is applicable to various forms of the second connecting member 3310. Especially, the shape and connection relationship of the accommodating portion 3110 and the cover body 3130 are applicable to various forms of the second connecting member 3310, and the form of the first connecting member 3120 can be correspondingly changed according to the form of the second connecting member 3310.

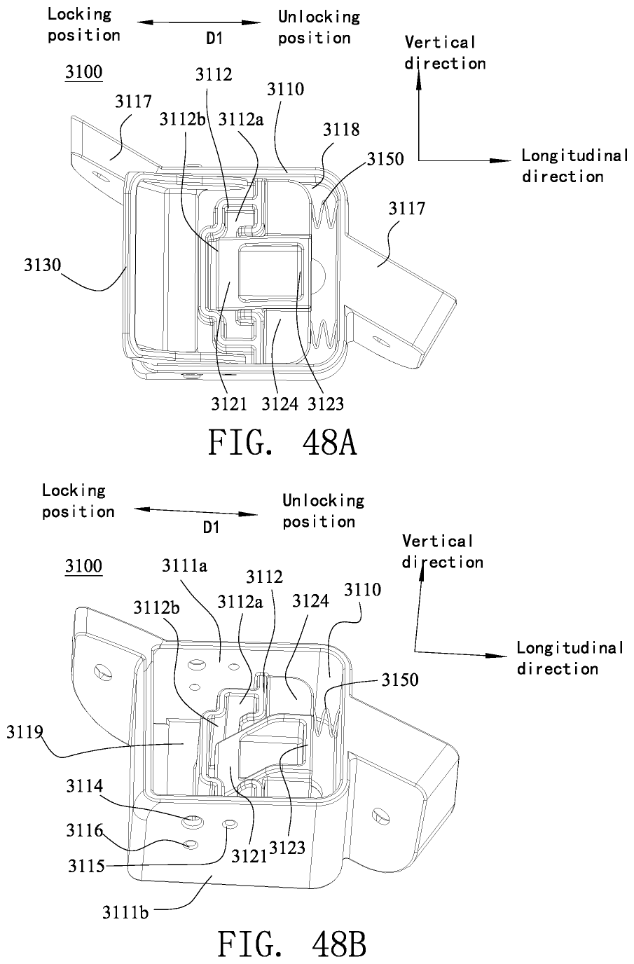

Referring to FIGS. 48A and 48B, the relationships between the components of the connecting structure 3100 are more clearly shown.

The first connecting member 3120 is arranged in the accommodating chamber 3118 of the accommodating portion 3110, so that the pressing portion 3123 faces the outer side of the accommodating portion 3110. The hook portion 3121 of the first connecting member 3120 is inserted into the clamping space 3112a of the accommodating portion 3110, and the resetting member 3150 is set between the abut portion 3124 of the first connecting member 3120 and the side wall of the accommodating portion 3110 to bias the first connecting member 3120 towards the locking position. The abut portion 3124 provides an abut position for the resetting member 3150, which can limit the resetting member 3150. The resetting member 3150 of the present embodiment is a spring, and the abut portion 3124 is equipped with a protruding portion 3124a (as shown in FIG. 46B) at the corresponding position of the resetting member 3150. The protruding portion 3124a can enter the spring to better position the spring. In this embodiment, the first connecting member 3120 extends in the vertical direction, and two resetting members 3150 are arranged in the vertical direction on both sides of the pressing portion 3123. However, in other embodiments, more or fewer resetting members 3150 may be provided, for example, only one resetting member 3150 may be provided, which is located at the center of the accommodating portion 3110 in the vertical direction and abuts against the middle position of the first connecting member 3120 in the vertical direction. In addition, in other embodiments, the number of the abut portions 3124 can be adjusted, for example, only one abut portion 3124 is matched with one resetting member 3150, or only one larger abut portion 3124 is matched with multiple resetting members 3150 simultaneously to limit the resetting member 3150.

In addition, in this embodiment, at least a portion of the extension wall 3112 is located on one side of the abut portion 3124 along the sliding direction D1 of the first connecting member 3120, and at least a portion of the extension wall 3112 is directly opposite to the abut portion 3124 along the sliding direction D1. When the first connecting member 3120 is in the locking position, the abut portion 3124 is close to or against the extension wall 3112. Therefore, when the first connecting member 3120 has a tendency to rotate around the guiding member 3140, at least a portion of the extension wall 3112 can resist the abut portion 3124, thereby avoiding the rotation of the first connecting member 3120 around the guiding member 3140 within the accommodating chamber 3118. Of course, in other embodiments, the outer wall of the connecting hole 3125 can be set as a non-circular wall (such as an elliptical or polygonal wall surface) and extended into the guide groove 3113a. The rotation of the first connecting member 3120 around the guiding member 3140 within the accommodating chamber 3118 can be restricted by the blocking and fitting relationship between the outer wall of the connecting hole 3125 and the guide groove 3113a.

Referring to FIGS. 49 to 53, describe the operation of the connecting structure 3100 according to the present application.

In the state shown in FIG. 49, the first connecting member 3120 is in the locking position, the cover body 3130 is in the open position, and the second connecting member 3310 is outside the connecting structure 3100. At this point, the first connecting member 3120 is biased to the locking position by the resetting member 3150. Due to the opening of the cover body 3130, the opening 3119 of the accommodating portion 3110 opens outward, allowing the second connecting member 3310 to be inserted into the accommodating portion 3110 through the opening 3119.

Starting from the state shown in FIG. 49, the user moves the second connecting member 3310 along the insertion direction D2 (i.e. the lateral direction in this embodiment) towards the interior of the accommodating portion 3110, so that the second connecting member 3310 enters the clamping space 3112a and abuts against the inclined plane 3126 of the first connecting member 3120, reaching the state shown in FIG. 50.

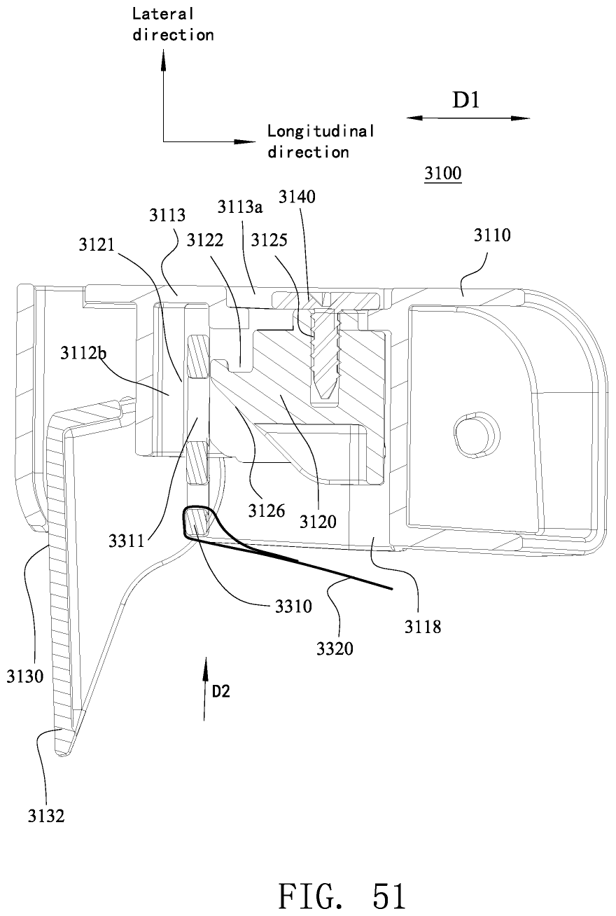

Starting from the state shown in FIG. 50, the user further moves the second connecting member 3310 towards the interior of the accommodating portion 3110 along the insertion direction D2. When the second connecting member 3310 enters the connecting structure 3100, it abuts against the inclined plane 3126, causing the first connecting member 3120 to resist the pressure of the resetting member 3150 under the push of the second connecting member 3310, and temporarily leaving the locking position and moving towards the unlocking position, thus reaching the state shown in FIG. 51.

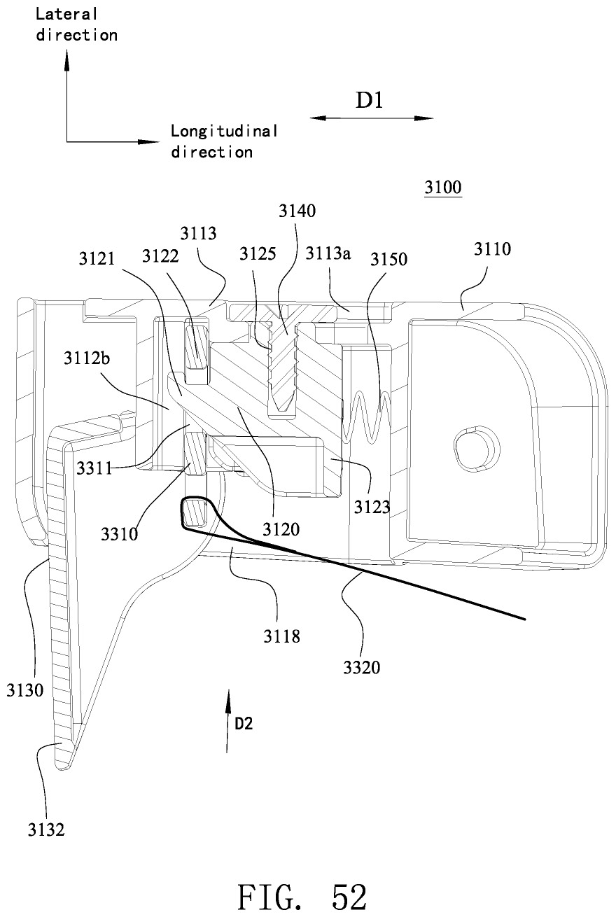

Starting from the state shown in FIG. 51, as the first connecting member 3120 is positioned in or closed to the unlocking position, it allows the second connecting member 3310 to continue moving towards the interior of the accommodating portion 3110 along the insertion direction D2. When the second connecting member 3310 enters the accommodating portion 3110, the clamping hole 3311 of the second connecting member 3310 corresponds to the position of the hook portion 3121, so that the first connecting member 3120 returns to the locking position under the action of the resetting member 3150, and the hook portion 3121 passes through the clamping hole 3311 to reach the state shown in FIG. 52.

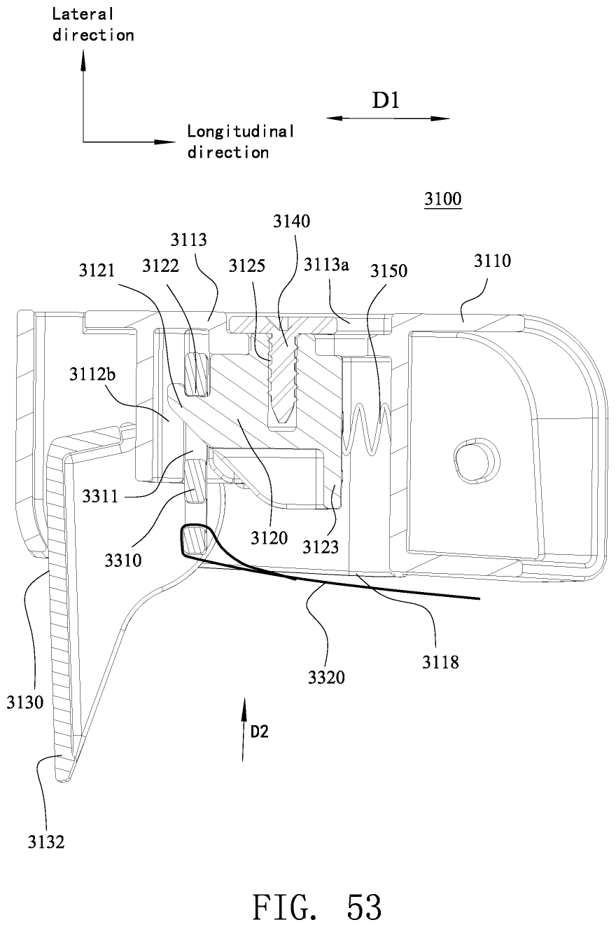

In the state shown in FIG. 52, the second connecting member 3310 is held in the holding portion 3110 by the first connecting member 3120. At this point, if the second connecting member 3310 is subjected to tension from the branch portion 3320 of the tether 3300, the second connecting member 3310 moves outward relative to the accommodating portion 3110 (i.e. moves in the opposite direction of the insertion direction D2), causing the second connecting member 3310 to get into the clamping portion 3122 of the accommodating portion 3110, as shown in FIG. 53. Therefore, the second connecting member 3310 cannot leave the first connecting member 3120, but is stably held in the accommodating portion 3110 by the first connecting member 3120, improving the safety performance of the connecting structure 3100.

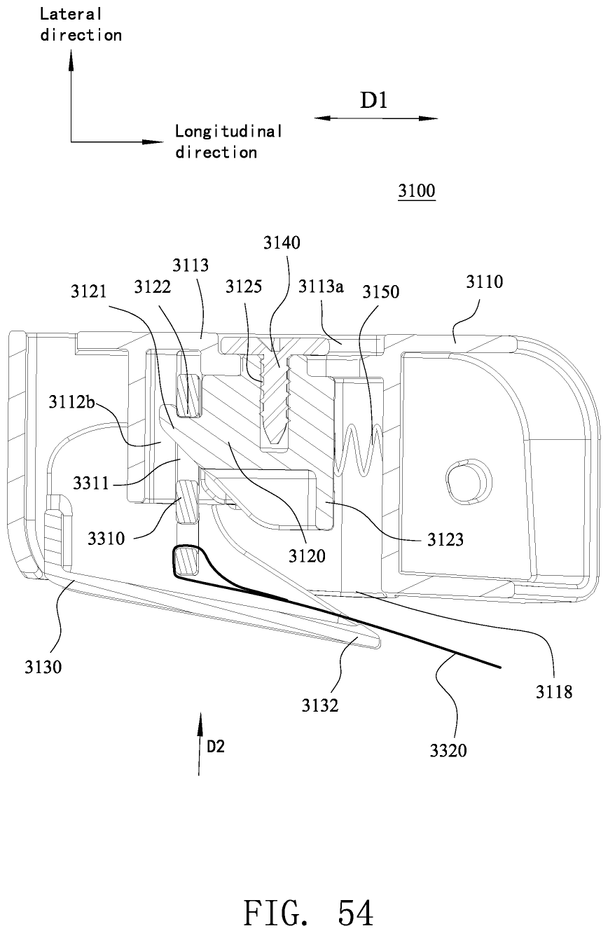

When the second connecting member 3310 enters the accommodating portion 3110, the user can pivot the cover body 3130 to the closed position, causing the connecting structure 3100 to reach the state shown in FIG. 54. When the cover body 3130 is in the closed position, the cover body 3130 blocks the second connecting member 3310 in the connecting structure 3100. The branch portion 3320 of the tether 3300 extends to the outside of the connecting structure 3100 through a gap between the free end 3132 of the cover body 3130 and the accommodating portion 3110. In FIG. 54, the gap between the free end 3132 of the cover body 3130 and the accommodating portion 3110 is depicted in an exaggerated manner. In fact, since the branch portion 3320 is made of flexible fabric, the gap can be so small that it is hardly visible from the outside of the connecting structure 3100. In this way, the cover body 3130 obscures the internal components of the connecting structure 3100 and the second connecting member 3310, giving the connecting structure 3100 a clean appearance. It can be understood that the cover body 3130 in the closed position has a certain limiting effect on the movement of the tether 3300, making the tether 3300 extend closer to the outer side of the seat body 3200.

The above context describes the operation of locking the second connecting member 3310 to the connecting structure 3100. When the user needs to detach the second connecting member 3310 from the connecting structure 3100, the above operations can be performed in reverse order. Specifically, the user first opens the cover body 3130, then presses the second connecting member 3310 towards the interior of the accommodating portion 3110 (i.e. press along the insertion direction D2) to detach the second connecting member 3310 from the clamping portion 3122 of the first connecting member 3120, and then moves the first connecting member 3120 to the unlocking position by operating the pressing portion 3123 to detach the hook portion 3121 from the clamping hole 3311, and finally, the second connecting member 3310 is removed from the accommodating portion 3110. It should be understood that after removing the second connecting member 3310, the user can close the cover body 3130 to restore the clean appearance of the connecting structure 3100 or prevent debris from entering the interior of the connecting structure 3100.

In summary, the present application provides a child safety seat with a connecting structure that can be opened and closed to connect a tether, and the insertion direction of the tether is different from the pulling direction of the tether. The present application further provides a connecting structure that has a simple and compact structure, can stably lock the second connecting member, and has a cover body that can be closed to provide a clean appearance.

Although preferred embodiments have been illustrated and described herein, it should be understood that these embodiments are only provided as examples. The person skilled in the art will think of many variations, changes, and replacements without deviating from the spirit of the present invention. Therefore, the accompanying claims aim to cover all such variations falling within the spirit and scope of the present invention.

1.-30. (canceled)

31. An infant basket, a side portion of the infant basket being provided with an engaging member and a cover member;
the engaging member defining a slot structure for engaging with an external safety belt, the slot structure having an engaging opening configured for the external safety belt to enter or leave the slot structure; and
the cover member having a first working mode and a second working mode, wherein in the first working mode, the engaging opening is at least partially covered by the cover member, preventing the external safety belt from entering the slot structure; and in the second working mode, the engaging opening is released by the cover member, allowing the external safety belt to enter the slot structure.

32. The infant basket according to claim 31, wherein,
the infant basket comprises a body forming a space for an infant to ride in;
the engaging member comprises a connection portion and an extension portion, the connection portion extends outward from a side portion of the body, the extension portion extends from an outer end of the connection portion, and an extension direction of the extension portion forms an angle with an extension direction of the connection portion;
the connection portion, the extension portion, and the side portion of the body together define the slot structure; and
the engaging opening is formed between one end of the extension portion away from the connection portion and the side portion of the body.

33. The infant basket according to claim 31, wherein,
the cover member is provided with a first opening corresponding to a position of the engaging member; and
in the first working mode, the engaging opening is covered by the cover member; during switch to the second working mode, the engaging member is adapted to pass through the first opening such that the engaging opening is exposed outside the cover member.

34. The infant basket according to claim 33, wherein the first opening is a hole or a slit, and/or, the cover member is provided with a sealing member for sealing the first opening.

35. The infant basket according to claim 33, wherein in the extension direction of the engaging member, a dimension of the first opening is smaller than a dimension of the engaging member; in a height direction perpendicular to the extension direction of the engaging member, the dimension of the first opening is greater than the dimension of the engaging member.

36. The infant basket according to claim 33, wherein in the first working mode, the first opening deviates from the engaging opening.

37. The infant basket according to claim 31, wherein a first positioning structure is provided between the cover member and the body, the cover member is detachably connected to the body through the first positioning structure; when the first positioning structure releases the positioning of the cover member, which allows the engaging member to pass through the first opening to expose the engaging opening outside the cover member.

38. The infant basket according to claim 31, wherein,
the infant basket comprises a body and a seat cloth, the seat cloth comprises a skirt edge that is folded outward from an upper edge of the body, and the cover member is formed by at least a portion of the skirt edge; a first positioning structure is provided between the skirt edge and the body; and
in the first working mode, the skirt edge covers the engaging member and is detachably connected to the body through the first positioning structure; during switch to the second working mode, the first positioning structure releases positioning of the skirt edge to allow the skirt edge to move upwards and the engaging opening is exposed.

39. The infant basket according to claim 38, wherein the first positioning structure is provided between the skirt edge and the side portion of the body.

40. The infant basket according to claim 31, wherein,
the infant basket comprises a body and a seat cloth, the seat cloth comprises a skirt edge that is folded outward from the upper edge of the body, the skirt edge is provided with a second opening, and the engaging member penetrates from the second opening; and
the cover member includes a movable cover connected to the seat cloth; in the first working mode, the movable cover covers the engaging member and is connected to the seat cloth through a second positioning structure; during switch to the second working mode, the second positioning structure releases positioning of the movable cover to allow the movable cover to move and expose the engaging member.

41. The infant basket according to claim 40, wherein a portion of an edge of the movable cover is sewn together with the seat cloth; or, the movable cover is detachably connected to the seat cloth.

42. The infant basket according to claim 31 wherein,
the infant basket comprises a body, which forms a space for infants to ride in;
the side portion of the body is provided with a recess, and the engaging member is located within the recess; and
the cover member comprises a cover body, in the first working mode, the cover body is located on the recess and covers the engaging member; during switch to the second working mode, the cover body opens the recess and exposes the engaging member.

43. The infant basket according to claim 42, wherein the cover body is pivotally connected to the body, and/or, the cover body is made of plastic or metal.

44. The infant basket according to claim 31, wherein the infant basket comprises a body and a seat cloth, and at least a portion of the seat cloth forms the cover member.

45. The infant basket according to claim 44, wherein the seat cloth comprises a skirt edge that is folded outward from an upper edge of the body, and the skirt edge forms the cover member.

46. The infant basket according to claim 31, wherein,
an accommodating space is formed in an interior of the cover member; the first end of the cover member is a fixed end, and a second end of the cover member is a free end; the cover member is provided with a third opening that is in communication with the accommodating space, and the third opening is located between the first end of the cover member and the second end of the cover member;
in the first working mode, the cover member is covered on the engaging member, and the engaging member enters the accommodating space through the third opening.

47. The infant basket according to claim 37, wherein,
the third opening is close to the second end of the cover member;
the cover member comprises a first surface and a second surface opposing to each other, the accommodating space is located between the first surface and the second surface, the third opening is provided on the first surface, and the third opening is close to the second end of the cover member; in the second working mode, the cover member is separated from the engaging member; during switch from the second working mode to the first working mode, the cover member flips relative to the first end of the cover member, causing the first surface to approach the engaging member.

48. The infant basket according to claim 46, wherein the infant basket comprises a body and a seat cloth, the seat cloth comprises a skirt edge that is folded outward from an upper edge of the body, and the first end of the cover member is connected to the skirt edge or the body.

49. The infant basket according to claim 46, wherein the infant basket comprises a body, and a limit hole is provided on a side portion of the body; the first end of the cover member is inserted into the limit hole, and the first end of the cover member is provided with a limit member that is clamped with the limit hole.

50. The infant basket according to claim 31, wherein
the infant basket has a first using mode and a second using mode; in the first using mode, the infant basket is suitable for application in vehicles; in the second using mode, the infant basket is suitable for application in aircraft;
when the infant basket is in the first using mode, making the cover member in the first working mode, the infant basket is suitable for detachable installation to a base, and the base is suitable for installation on a vehicle seat;
when the infant basket is in the second using mode, making the cover member in the second working mode, and the infant basket is suitable for installation on an aircraft seat through a safety belt passing through the slot structure.
